(19) United States
(12) Patent Application Publication
(10) Pub. No.: US 2024/0132355 A1
(43) Pub. Date: Apr. 25, 2024

(54) CONTINUOUS CARBON FOAM MATERIAL MANUFACTURING SYSTEMS AND METHODS

(71) Applicant: Ohio University, Athens, OH (US)

(72) Inventors: Jason Patrick Trembly, Athens, OH (US); Yahya Taha Al-Majali, Albany, OH (US)

(21) Appl. No.: 18/494,373

(22) Filed: Oct. 24, 2023

Related U.S. Application Data
(60) Provisional application No. 63/380,886, filed on Oct. 25, 2022.

(51) Int. Cl. C01B 32/05; B01J 6/00; E04F 13/14

(52) U.S. Cl. CPC C01B 32/05; B01J 6/008; E04F 13/14

(57) ABSTRACT

A system and method for producing a coal product from a carbon source material. The coal product may include a green carbon foam, a finished carbon foam, and/or a coal siding product. The system and method for producing a green carbon foam may involve pulverizing the carbon source material prior to processing the pulverized carbon source material to produce the green carbon foam using a float bath or an extruder. During production of the green carbon foam, the temperature of the float bath or extruder may be maintained at a temperature determined relative to the Gieseler fluidity properties of the carbon source material used.

### FIELD OF THE INVENTION

Exemplary embodiments of the present invention relate generally to systems and methods for producing carbon foam materials.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Carbon foam products have been conventionally made using coal via one of two methods. First, a coal extract can be soft coked at elevated temperature and elevated pressures (greater than 500 psig). By coking the coal extract, the coal extract decomposes into lower boiling products, such as pitch. At a high enough temperature, the coal material exceeds a softening temperature (greater than 250° C.) and begins to flow. By lowering the heightened pressure applied to the coal material after exceeding the softening temperature, trapped gases within the voids of pitch material expand and are released, producing a carbon foam from the pitch. Second, coal binder pitch can be blended with a caking coal and coked under high pressures and temperatures as disclosed above. The foams produced using these methods are green carbon foams, meaning that the foams have a high percentage of volatile materials that can be calcinated or vitrified to increase the strength of the green carbon foam through further heating.

However, these processes have several notable drawbacks. Most significantly, by requiring that high pressures be applied to the coal material to produce a green carbon foam, the equipment and operating costs exponentially increase with scale, which prevents scaling the process to mass production cost effectively. Additionally, by requiring that high pressures be maintained in sections of the reaction, it is not possible to implement a continuous throughput of foam as the high-pressure chamber creates a bottleneck in the process.

Alternatively, carbon foams have been conventionally created by pyrolyzing a polymer foam, such as a polyurethane foam. The pyrolization process is able to release the volatile material(s) contained within the polymer foam, leaving a pure carbon skeleton behind which constitutes a carbon foam. However, by removing the volatile materials to produce the carbon foam, the resulting carbon foam is not a green carbon foam that can be subjected to vitrification or calcination. Accordingly, the resulting foam product is friable and does not have appreciable strength.

Accordingly, there is a need for a system and method for producing green carbon foam materials or coal products therefrom at scale that is cost effective. There is also a need for a system and method capable of continuously producing a green carbon foam materials or coal products therefrom at scale that is cost effective.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Exemplary embodiments of the present invention may satisfy some or all of the needs described above. One embodiment of the present invention is a system or method for producing a green carbon foam material from coal via a differential density float system. Another exemplary embodiment is a system or method for producing a green carbon foam material made from a carbon source material selected from the group consisting of coal, carbon black, coke, coke breeze, carbon foam, coal tar pitch, petroleum pitch, carbon foam dust, petroleum coke, biochar, and charcoal. In a further embodiment, the system or method for producing a green carbon foam is configured to include an additive selected from the group consisting of chemical foaming agents, process aids, thermoset resins, thermoplastic resins, crosslinkers, fibers, carbon fibers, metals, and metal fibers.

Another embodiment of the invention is a system or method for producing a coal product via a differential density float system. Yet another exemplary embodiment is a system or method for producing a coal product from a carbon source material selected from the group consisting of coal, carbon black, coke, coke breeze, carbon foam, carbon foam dust, petroleum coke, biochar, lignin, lignocellulose, and charcoal. In a further embodiment, the system or method for producing a coal product is configured to produce a coal product including an additive selected from the group consisting of chemical foaming agents, process aids, thermoset resins, thermoplastic resins, crosslinkers, fibers, carbon fibers, metals, and metal fibers.

Another embodiment of the present invention is a system or method for producing a green carbon foam material from coal via an extrusion system. Another exemplary embodiment is a system or method for producing a green carbon foam material made from a carbon source material selected from the group consisting of coal, carbon black, coke, coke breeze, carbon foam, coal tar pitch, petroleum pitch, carbon foam dust, petroleum coke, biochar, and charcoal. In a further embodiment, the system or method for producing a green carbon foam that is configured to include an additive selected from the group consisting of chemical foaming agents, process aids, thermoset resins, thermoplastic resins, crosslinkers, fibers, carbon fibers, metals, and metal fibers.

Another embodiment of the invention is a system or method for producing a coal product via an extrusion system. Yet another exemplary embodiment is a system or method for producing a coal product from a carbon source material selected from the group consisting of coal, carbon black, coke, coke breeze, carbon foam, carbon foam dust, petroleum coke, biochar, lignin, lignocellulose, charcoal, coal tar, coal tar pitch, and petroleum pitch. In a further embodiment, the system or method for producing a coal product is configured to produce a coal product including an additive selected from the group consisting of chemical foaming agents, process aids, thermoset resins, thermoplastic resins, crosslinkers, fibers, carbon fibers, metals, and metal fibers.

One embodiment of the invention is a system (hereinafter “the System”) configured to continuously produce a coal product, wherein the coal product is selected from the list consisting of a green carbon foam, a finished carbon foam, and a coal siding product, the system including: a carbon material source tank; an air heater; a pulverizer, wherein the pulverizer is configured to receive a carbon source material from the carbon source material tank, wherein the pulverizer is configured to receive heated air from the air heater, and wherein the pulverizer is configured to produce a pulverized carbon source material; and a green carbon foam processing device selected from the group consisting of a float bath and an extruder, wherein the green carbon foam processing device is configured to receive a material selected from the group consisting of the pulverized carbon source material and a carbon material sheet, wherein the green carbon foam processing device is configured to have a temperature greater than the softening temperature and less than the solidification temperature of the carbon source material, and wherein the green carbon foam processing device is configured to produce a green carbon foam.

In a further embodiment of the System, the carbon source material includes a caking coal. In a yet further embodiment of this system, the caking coal includes a coal selected from the list consisting of Pittsburgh No. 8 coal, White Forest Coal, and Itmann coal.

In an alternate further embodiment of the System, the system further includes a first mesh having a first mesh size, wherein the first mesh is configured to receive the pulverized carbon source material prior to the green carbon foam processing device, and wherein the green carbon foam device is configured to receive only the carbon source material having a size smaller than the openings of the first mesh. In a further embodiment thereof, the first mesh size is selected from the list consisting of an 80M size, a 35M size, and a 14M size. In another alternate embodiment thereof, the system further includes a second mesh having a second mesh size, wherein the second mesh size is larger than the first mesh size, wherein the second mesh is configured to receive the pulverized carbon source material from the first mesh prior to the green carbon processing device, and wherein the green carbon foam device is configured to receive only the carbon source material having a size larger than the openings of the second mesh. In a further embodiment thereof, the second mesh size is selected from the list consisting of an 80M size and a 35M size.

In an alternate further embodiment of the System, the system further includes: a blender configured to receive the pulverized carbon source material prior to the green carbon foam processing device, wherein the blender is configured to mix together all received components; and an additives tank configured to supply one or more additive to a device selected from the group consisting of the pulverizer and the blender. In a further embodiment therefrom, the one or more additive includes graphite, and wherein graphite is included in an amount greater than or equal to 0.01 wt. % and less than or equal to 10 wt. % by weight of the mixture. In an alternate further embodiment therefrom, the one or more additive includes carbon fiber, and wherein carbon fiber is included in an amount greater than or equal to 0.01 wt. % and less than or equal to 10 wt. % by weight of the mixture. In another alternate further embodiment therefrom, the one or more additive includes a binder selected from the list consisting of cellulose, methyl cellulose, and some combination thereof, wherein the binder is included in an amount less than or equal to 10 wt. % by weight of the mixture.

In another alternate further embodiment of the System, the system further includes a kiln, wherein the kiln is configured to receive the green carbon foam from the green carbon foam processing device, and wherein the kiln is configured to produce a finished carbon foam. In a further embodiment therefrom, the system further includes a primer device, wherein the primer device configured to receive the finished carbon foam from the kiln, and wherein the primer device is configured to produce a coal siding product.

In another alternate further embodiment of the System, the system further includes a primer device, wherein the primer device is configured to receive the green carbon foam from the green carbon foam processing device, and wherein the primer device is configured to produce a coal siding product.

In another further embodiment of the System, the system further includes a pulling device, wherein the pulling device is positioned downstream from the green carbon foam processing device and is configured to receive the green carbon foam only after the green carbon foam is cooled to solidify.

In another alternate further embodiment of the System, the system is configured to have a maximum operating temperature and a minimum operating temperature when producing a green carbon foam, and wherein the maximum temperature is defined relative to the solidification temperature of the carbon source material, wherein the maximum operating temperature is selected from a list consisting of at least 5° C. below the solidification temperature, at least 10° C. below the solidification temperature, at least 20° C. below the solidification temperature, and at least 30° C. below the solidification temperature; and wherein the minimum temperature is defined relative to the softening temperature of the carbon source material, wherein the minimum temperature is selected from a list consisting of at least 5° C. above the softening temperature, at least 10° C. above the softening temperature, at least 20° C. above the softening temperature, and at least 30° C. above the softening temperature.

In another alternate further embodiment of the System, the green carbon foam processing device is an extruder, and wherein the extruder includes a two-stage auger, the two stage auger including: a first portion configured to be heated to a first temperature, wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and a second portion configured to be heated to a second temperature, wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

In another alternate further embodiment of the System, the green carbon foam processing device includes a first float bath that is configured to have a first temperature, and wherein the system further includes a second float bath configured to receive the output from the first float bath, wherein the second float bath is configured to have a second temperature; wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

One embodiment of the invention is a method (hereinafter “the Method”) for continuously producing a coal product, wherein the coal product is selected from the list consisting of a green carbon foam, a finished carbon foam, and a coal siding product, the method including: drying a carbon source material; pulverizing the carbon source material to produce a pulverized carbon source material; processing the pulverized carbon source material to produce a green carbon foam, wherein said processing includes using a green carbon foam processing device selected from the group consisting of a float bath and an extruder, wherein said processing includes: maintaining the pulverized carbon source material at a temperature greater than the softening temperature of the carbon source material; and maintaining the pulverized carbon source material at a temperature less than the solidification temperature of the carbon source material.

In a further embodiment of the Method, the carbon source material includes a caking coal. In a further embodiment therefrom, the caking coal includes a coal selected from the list consisting of Pittsburgh No. 8 coal, White Forest Coal, and Itmann coal.

In an alternate further embodiment of the Method, the method further includes a first mesh separation step using a first mesh, wherein the first mesh has a first mesh size, wherein the first mesh separation step occurs prior to processing the pulverized carbon source material to produce the green carbon foam, and wherein only the carbon source material having a size smaller than the openings of the first mesh is processed to produce the green carbon foam. In a further embodiment therefrom, the first mesh size is selected from the list consisting of an 80M size, a 35M size, and a 14M size. In an alternate further embodiment therefrom, the method further includes a second mesh separation step using a second mesh, wherein the second mesh has a second mesh size that is larger than the first mesh size, wherein the second mesh separation step occurs after the first mesh separation step and before processing the pulverized carbon foam to produce a green carbon foam, and wherein only the carbon source material having a size larger than the openings of the second mesh is processed to form a green carbon foam. In a further embodiment therefrom, the second mesh size is selected from the list consisting of an 80M size and a 35M size.

In another alternate further embodiment of the Method, the method further includes: prior to processing the pulverized carbon source material to produce the green carbon foam, adding one or more additive to one of the carbon source material and/or the pulverized carbon source material; and prior to processing the pulverized carbon source material to produce the green carbon foam, mixing the pulverized carbon source material and the one or more additive together. In a further embodiment therefrom, the one or more additive includes graphite, and wherein graphite is included in an amount greater than or equal to 0.01 wt. % and less than or equal to 10 wt. % by weight of the mixture. In an alternate further embodiment therefrom, the one or more additive includes carbon fiber, and wherein carbon fiber is included in an amount greater than or equal to 0.01 wt. % and less than or equal to 10 wt. % by weight of the mixture. In yet another alternate further embodiment therefrom, the one or more additive includes a binder selected from the list consisting of cellulose, methyl cellulose, and some combination thereof, and wherein the binder is included in an amount less than or equal to 10 wt. % by weight of the mixture.

In another alternate further embodiment of the Method, the method further includes processing the green carbon foam to produce finished carbon foam, wherein processing the green carbon foam to produce a finished carbon foam includes a heat-treatment process selected from the list consisting of vitrification, calcination, and graphitization. In a further embodiment therefrom, the method further includes applying a coating to the finished carbon foam to produce a coal siding product.

In another alternate further embodiment of the Method, the method further includes applying a coating to the green carbon foam to produce a coal siding product.

In another alternate further embodiment of the Method, the method further includes: after producing the green carbon foam, allowing the green carbon foam to cool to solidify; and after allowing the green carbon foam to cool to solidify, pulling the green carbon foam downstream from the green carbon foam processing device.

In another alternate further embodiment of the Method, maintaining the pulverized carbon source material at a temperature greater than the softening temperature of the carbon source material includes maintaining a minimum temperature, wherein the minimum temperature is selected from a list consisting of at least 5° C. above the softening temperature, at least 10° C. above the softening temperature, at least 20° C. above the softening temperature, and at least 30° C. above the softening temperature; and maintaining the pulverized carbon source material at a temperature less than the solidification temperature of the carbon source material includes maintaining a maximum temperature, wherein the maximum operating temperature is selected from a list consisting of at least 5° C. below the solidification temperature, at least 10° C. below the solidification temperature, at least 20° C. below the solidification temperature, and at least 30° C. below the solidification temperature.

In another alternate further embodiment of the Method, wherein the green carbon foam processing device is an extruder having a two stage auger, the two stage auger including a first portion and a second portion, the method further includes: maintaining the first portion at a first temperature, wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and maintaining the second portion at a second temperature, wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

In another alternate further embodiment of the Method, wherein processing the pulverized carbon source material to produce a green carbon foam includes using a first float bath and a second float bath, the method further includes: maintaining the first float bath at a first temperature, wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and maintaining the second float bath at a second float bath temperature, wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

In another alternate further embodiment of the Method, wherein processing the pulverized carbon source material to produce a green carbon foam includes using a float bath, the method further includes: immediately prior to processing the pulverized carbon source material to produce a green carbon foam, processing the pulverized carbon source material to produce a carbon material sheet, wherein processing the pulverized carbon source material to produce a green carbon foam includes processing the carbon material sheet to produce a green carbon foam.

In addition to the novel features and advantages mentioned above, other benefits will be readily apparent from the following descriptions of exemplary embodiments.

### BRIEF DESCRIPTION OF THE DRAWINGS

The accompanying drawings, which are incorporated in and constitute a part of this specification, illustrate embodiments of the invention and, with a detailed description of the embodiments given below, serve to explain the principles of the invention.

FIG. 1 is a flow diagram showing a system and method for producing a green carbon foam or a coal product in accordance with an embodiment of the invention.

FIG. 2 is a flow diagram showing a system and method for producing a green carbon foam or a coal product in accordance with an embodiment of the invention.

FIG. 3 is a cross-sectional view of a float bath in accordance with one embodiment of the invention.

FIG. 4 is a flow diagram showing a system and method for producing a green carbon foam or a coal product in accordance with an embodiment of the invention.

FIG. 5 is a flow diagram showing a system and method for producing a green carbon foam or a coal product in accordance with an embodiment of the invention.

FIG. 6 is a cross-sectional view of an extruder in accordance with one embodiment of the invention.

FIG. 7 is a cross-sectional view of an extruder in accordance with one embodiment of the invention.

FIG. 8 is a cross-sectional view of an extruder in accordance with one embodiment of the invention.

FIG. 9 is a cross-sectional view of a coal product in accordance with one embodiment of the invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Exemplary embodiments of the present invention are directed to carbon foams comprising carbon source material. Related components and manufacturing methods are also included. Relative to the known art, exemplary embodiments may include carbon foams having improved or similar physical characteristics such as strength, stiffness, impact resistance, extrudability, resistance to thermal degradation, resistance to moisture, resistance to mold, resistance to mildew, and/or resistance to flammability. Relative to the known art, exemplary embodiments may also satisfy the need for the use of different carbon sources, carbon chains, and/or carbon sizes.

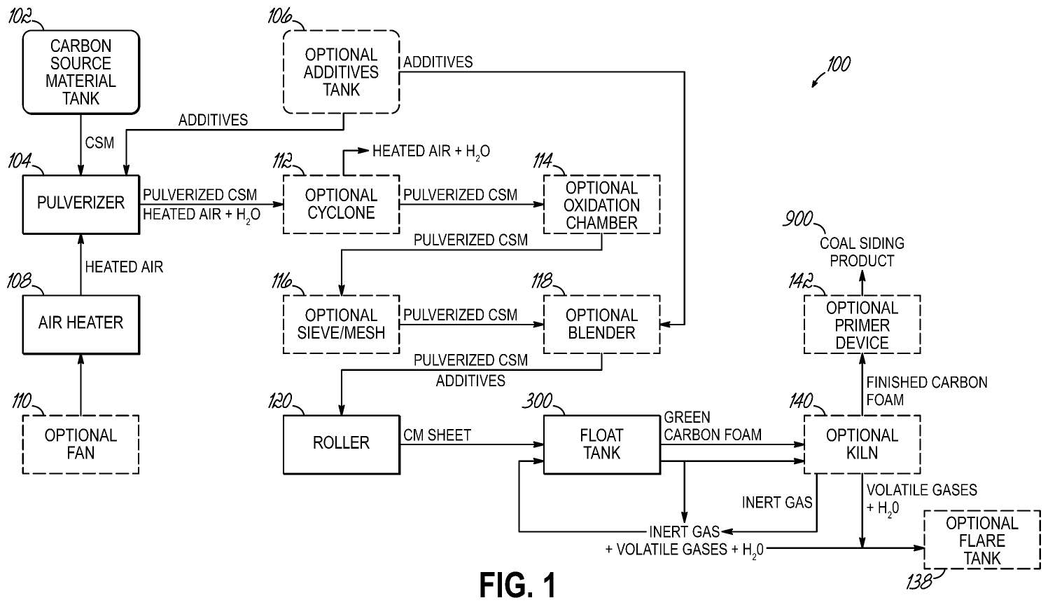

With reference to FIGS. 1-2 and 4-5, a system and method 100, 200, 400, 500 for producing a coal product 900 is shown. The system and method 100, 200, 400, 500 includes a carbon source material tank 102 containing a carbon source material. The carbon source material includes at least one carbon-based material. The carbon source material may include, for example, a single type of carbon-based material, a mixture of a plurality of carbon-based materials, or a mixture of one or more carbon-based materials and one or more non-carbon-based materials. In embodiments including one or more non-carbon based material, the material may be incorporated into the carbon-based material initially or may be added to the carbon-based material to form the carbon source material. The at least one carbon-based material may be selected from the group consisting of, by way of example and not limitation, coal, waste coal, oxidized coal, carbon black, coke, coke breeze, carbon foam, carbon foam dust, petroleum coke, pitch, biochar, lignin, lignocellulose, charcoal, and other suitable materials containing carbon. In one embodiment, the carbon source material includes a caking coal. In a further embodiment, the carbon source material includes a carbon source material selected from the list consisting of Pittsburgh No. 8 coal, White Forest coal, and Itmann coal. The carbon-based material may be or include an industrial product or byproduct that is predominantly carbon such as, for example, coke (e.g., petroleum coke), coke breeze, pitch, or other suitable carbon-based industrial byproducts. Those of ordinary skill in the art, however, will recognize that “coke” may refer to substances other than petroleum coke; coke could also refer to, for example, coal-derived coke (e.g., metallurgical coke or foundry coke), an industrial product (e.g., metallurgical coke), an industrial byproduct (e.g., coke breeze), or other coal-based materials. An example of waste coal may comprise coal and optionally inorganic materials (e.g., soil). An example of oxidized coal is coal which has been exposed to oxygen or oxygen containing atmosphere at a sufficient temperature to induce oxidation of the coal surface, but not to include devolatilization of the material. Further examples of waste coal may include, for example: fine coal refuse, waste coal slurry, tailings, or settling pond material; coarse coal refuse or hollow fill material; intermediate prep plant streams or middlings; fly ash with intermixed carbon (loss on ignition); and refined carbon materials derived from the above waste streams. Examples of biochar may be derived from woody biomass, non-woody biomass, animal/human waste, and algae.

The non-carbon-based material may be, for example, a metal, an alloy, a ceramic, a composite material, a semi-conductor, some other similar material, or some combination thereof. One or more of these non-carbon based materials may be included in the carbon source material to impart or enhance a property of the resulting coal product 900 such as, for example, the strength, the electrical conductivity, the thermal conductivity, stiffness, resilience, modulus of elasticity, density, impact resistance, or some combination thereof. In one embodiment, the non-carbon material includes a metal or alloy such as, for example, steel, iron, aluminum, chromium, titanium, cobalt, lead, nickel, manganese, molybdenum, copper, an alloy including one or more of the aforementioned metals, or some combination thereof that enhances the strength of the coal product 900. In one embodiment, the non-carbon material includes a metal or alloy such as, for example, copper, gold, aluminum, silver, an alloy including one or more of the aforementioned metals, or some combination thereof that imparts or enhances electrical conductivity of the coal product 900. In one embodiment, the non-carbon material includes a metal or alloy such as, for example, copper, gold, aluminum, silver, beryllium, iron, magnesium, molybdenum, nickel, rhodium, tungsten, zinc, an alloy including one or more of the aforementioned metals, or some combination thereof to impart or enhance thermal conductivity of the coal product 900.

Exemplary embodiments may also implement various types of coal chemistry. For example, since the carbon source material is not meant to be burned, carbon source material may comprise any level of volatile matter, macerals, sulfur, ash, minerals, impurities, hardness (e.g., Hardgrove Grindability Index), etc., which may facilitate the use of materials that otherwise have little or no alternative value. In exemplary embodiments, the type of carbon source material may be selected based on one or more properties of the coal product 900 such as, for example, mechanical properties, fire resistance, oxidation resistance, other relevant properties of a coal product 900, such as a coal siding product, or some combination thereof. In exemplary embodiments where carbon source material contains both carbon-based materials and non-carbon-based materials, the carbon-based material may account for greater than or equal to 90% by weight of the carbon source material.

Exemplary embodiments of the carbon source material can include particles of varying sizes. The carbon source material may have a particle size that is determined or selected by using a separation technique such as, for example, mesh separation or sieve separation prior to entering the carbon source material tank 102. When using a mesh or sieve to separate particles out by size, the mesh size given in units M indicates the number of openings per square inch of mesh. Accordingly, the higher the mesh size number, the smaller the opening and the smaller the particles must be in order to be able to pass through said opening. For example, an 80M size has openings with a size of 180 microns, a 35M size has openings with a size of 500 microns, and a 14 mesh size has openings with a size of 1.4 mm. Additionally, more than one mesh can be used in series to select for a range of particle sizes by selecting particles both having a size smaller than the larger mesh openings and having a size larger than the smaller mesh openings. In one embodiment, a first mesh (not shown) having a mesh size is used to select the size of the carbon source material entering the carbon source material tank, wherein the first mesh size may be selected from the list consisting of an 80M size, a 35M size, and a 14M size. In a further embodiment thereof, a second mesh (not shown) having a second mesh size is used thereafter, wherein the second mesh size may be selected from the list consisting of a 35M size and a 80M size. In one embodiment, particle sizes of carbon source material entering may range from 1-1,000 μm. In an alternate embodiment, particle sizes of the carbon source material may range from 1-500 μm. In yet another alternate embodiment, the particle sizes may range from 1-100 μm. In still another alternate embodiment, particle sizes of carbon source material may range from 1-18 μm, which may include carbon dust.

The carbon source material tank 102 is connected to a pulverizer 104 that is configured to receive the carbon source material. The pulverizer 104 may be used to reduce the particle size of the carbon source material by, for example, grinding, crushing, milling (e.g., a hammer mill, a ball mill, etc.), other suitable particle size reduction techniques, or some combination thereof. In one embodiment, the carbon source material may be ground to a particle size between about 5-300 μm. In an alternate embodiment, the carbon source material may be ground to a particle size between about 25-50 μm. The particle size of the or the carbon source material may be determined or selected based on a duration of pulverization for the carbon source material.

An optional additives tank 106 may contain one or more additives that are added to the carbon source material. In one embodiment, the optional additives tank 106 is configured to add the one or more additives to the carbon source material at the pulverizer 104. In another embodiment, the optional additives tank is configured to add the one or more additives to the carbon source material at the optional blender 118 (discussed further below).

The one or more additives may be added to the carbon source material to improve the manufacturing of at least one of the green carbon foam and coal product 900 and/or to improve the performance of at least one of the green carbon foam and coal product 900. With regard to improving the manufacturing of at least one of the green carbon foam and the coal product 900, the one or more additives may include, for example, a process aid, a binder, a chemical foaming agent, an anti-foaming agent, a lubricant, another suitable additive for improving the manufacturing of a coal product 900, or some combination thereof. In one such embodiment, the process aid is selected from the group consisting of graphite and carbon fiber in an amount greater than or equal to 0.01 wt. % and less than or equal to 10 wt. % by weight of the mixture. With regard to improving the performance of at least one of the green carbon foam and the coal product 900, the one or more additives may include, for example, a fiber, a thermoset resin, a thermoplastic resin, a crosslinking agent, a metal, inorganic material, other suitable additives for improving performance of the coal product 900, or some combination thereof.

In one embodiment, the one or more additives includes a process aid such as, for example, a binder (discussed further below), a fiber, a metal, or some combination thereof. In a further embodiment thereof, the binder may include, for example, ethyl acrylate, butyl acrylate, 2-ethylhexyl acrylate, methyl methacrylate, acrylic acid, methyl acrylate, and combinations thereof, polyvinylidene chloride latex, styrene-butadiene latex, carboxylated acrylonitrile butadiene rubber, carboxylated butadiene copolymer rubber, styrene-acrylic emulsion polymers including resin supported emulsions, vinyl-acetate based polymers such as vinyl acetate ethylene copolymers and vinyl acrylic latex, nitrile latex elastomers, nitrile-butadiene elastomers, polybutadiene elastomers produced from 1,3-butadiene elastomers, dicyclopentadiene-based elastomers, ethylene propylene dicyclopentadiene-based elastomers, neoprene binder, natural rubber binder, water-based polyurethane elastomers, starch/dextrin-based binders, protein/casein-based binders, silicone-based binders, cellulose, methyl cellulose, other suitable binders, and combinations thereof. In one embodiment, the one or more additives includes a chemical foaming agent such as, for example, sodium bicarbonate, ammonium carbonate, ammonium bicarbonate, calcium azide, azodicarbonamide, hydrazocarbonamide, benzenesulfonyl hydrazide, dinitrosopentamethylene tetramine, toluenesulfonyl hydrazide, p,p′-oxybis(benzenesulfonylhydrazide), azobisisobutyronitrile, barium azodicarboxylate, other suitable chemical foaming agents, or some combination thereof. In one embodiment, the additive includes an antifoaming agent such as, for example, an oil-based anti-foaming agent (e.g., a mineral oil, a vegetable oil, or another oil that is insoluble in the carbon foam), a silicon-based antifoaming agent (e.g., a polymer with a silicon backbone, a hydrophobic silica, silicone glycol), an alkyl polyacrylate, some other suitable additive that reduces or inhibits foaming, or some combination thereof. In one embodiment, the one or more additive includes a lubricant such as, for example, a solid lubricant (e.g., a lamellar solids such as graphite, PTFE, etc.), oil-based lubricants, water-based lubricants, silicone based lubricants, other suitable lubricants, or some combination thereof. In one embodiment, the additive includes a fiber such as, for example, a carbon fiber, a carbon nanotube, a metal fiber, an inorganic fiber, some other suitable fibrous material, or some combination thereof to improve performance of the coal product 900. In one embodiment, the one or more additives includes a thermoset resin such as, for example, an epoxy resin, a phenolic resin, a bismaleimide resin, a fluoropolymer resin, some other suitable resin, or some combination thereof. In one embodiment, the one or more additives includes a thermoplastic resin such as, for example, (ABS), acrylic, high density polyethylene (HDPE), polypropylene (PP), polyethylene (PE), polystyrene (PS), polyvinyl chloride (PVC), styrene, polybutylene (PBT), polyethylene terephthalate (PET), polycarbonate, polyethylenimine (PEI), polyether sulfone (PES), polysulfone (PSU), polyphenylene ether (PPE), nylon, polyphenylene sulfide (PPS), thermoplastic polyurethane (TPU), Teflon, thermoplastic rubber (TPR), cyclic olefin copolymer (COC), cyclic opyfin polymer (COP), liquid crystal polymers (LCP), some other suitable monomer/polymer, or some combination thereof. In one embodiment, the one or more additives includes a crosslinking agent such as, for example, dialdehydes (e.g., glutaraldehyde (GA), phthalaldyhyde (OPA)), hydrazides, alkoxyamines, isocyanates, carbodiamides, some other suitable crosslinking agent, or some combination thereof. In one embodiment, the one or more additives includes a metal or metal fiber made of, for example, steel, iron, aluminum, chromium, titanium, cobalt, lead, nickel, manganese, molybdenum, copper, gold, silver, beryllium, magnesium, rhodium, tungsten, zinc, an alloy including one or more of the aforementioned metals, or some combination thereof.

One or more of these additives may be added to the pulverized carbon source material to define a composite material formulation. In exemplary embodiments, the one or more additives collectively are included in an amount less than or equal to 20% by weight of the composite material formulation, or alternatively in an amount less than or equal to 10% by weight of the composite, or yet alternatively in an amount less than or equal to 5% by weight of the composite material formulation, or still alternatively in an amount less than or equal to 1% by weight of the composite material formulation. In one embodiment, the one or more additives includes a process aid in an amount between 0-7% by weight of the composite material formulation to improve the manufacturing of at least one of the green carbon foam and the coal product 900. In an alternate embodiment, the one or more additives includes a process aid in an amount between 0.05-3% to improve the manufacturing of at least one of the green carbon foam and the coal product 900. In yet another alternate embodiment, the one or more additives includes a process aid in an amount between 0.05-1.0% by weight of the composite material formulation to improve the manufacturing of at least one of the green carbon foam and the coal product 900. In one embodiment, the one or more additives includes a chemical foaming agent to improve the manufacturing of at least one of the green carbon foam and the coal product 900. In one embodiment, the one or more additives includes a fiber in an amount between 0-7% by weight of the composite to improve the performance of at least one of the green carbon foam and the coal product 900. In an alternate embodiment, the one or more additives includes a fiber in an amount between 0.05-2% to improve the performance of at least one of the green carbon foam and the coal product 900. In yet another alternate embodiment, the one or more additives includes a fiber in an amount between 0.05-1.0% by weight of the composite material formulation to improve the performance of at least one of the green carbon foam and the coal product 900. In one embodiment, the one or more additives includes at least one plastic from the group consisting of a thermoset resin and a thermoplastic resin in an amount between 1-10% by weight of the composite material formulation to improve the performance of at least one of the green carbon foam and the coal product 900. In one embodiment, the one or more additives includes a crosslinking agent in an amount between 0.5-5.0% by weight of the composite material formulation to improve the performance of at least one of the green carbon foam and the coal product 900. In one embodiment, the one or more additives includes at least one of a metal or a metal fiber in an amount between 0.5-5.0% by weight of the composite material formulation to improve the performance of at least one of the green carbon foam and the coal product 900. In one embodiment, the one or more additive includes a binder in an amount less than or equal to 10% by weight of the composite material formulation. As discussed further below, such embodiments incorporating a metal or metal fiber result in a carbon foam-metal composite.

One or more of these additives may be added to the pulverized carbon source material to impart or enhance a property of the resulting coal product 900 such as, for example, the strength, the electrical conductivity, the thermal conductivity, stiffness, resilience, modulus of elasticity, density, impact resistance, or some combination thereof. It should be understood that further references to a carbon material source and a carbon material sheet (described further below) may refer to composite materials or composite material formulations in embodiments where one or more additives are added. In one embodiment, the one or more additive includes a metal or metal fiber such as, for example, steel, iron, aluminum, chromium, titanium, cobalt, lead, nickel, manganese, molybdenum, copper, an alloy including one or more of the aforementioned metals, or some combination thereof that enhances the strength of the coal product 900. In one embodiment, the one or more additive includes a metal or metal fiber such as, for example, copper, gold, aluminum, silver, an alloy including one or more of the aforementioned metals, or some combination thereof that imparts or enhances electrical conductivity of the coal product 900. In one embodiment, the one or more additive includes a metal or metal such as, for example, copper, gold, aluminum, silver, beryllium, iron, magnesium, molybdenum, nickel, rhodium, tungsten, zinc, an alloy including one or more of the aforementioned metals, or some combination thereof to impart or enhance thermal conductivity of the coal product 900. Metal fibers may be used in addition to or instead of ordinary metals (e.g., metal particles) to increase the strength of the resulting green carbon foam or coal product 900 over a comparable embodiment only using a metal.

An air heater 108, which produces heated air, is further connected to the pulverizer 104 such that the pulverizer 104 is configured to receive the heated air mix the heated air with the carbon source material. An optional fan 110 may be connected to the air heater 108 such that the optional fan 110 is configured to increase the rate at which heated air is added to the pulverizer 104. The heated air may help dry the carbon source material, before, during, or after pulverization, removing water therefrom as water vapor. In one embodiment, the carbon source material is subjected to the heated air until most or all surface moisture is removed. Determining that most or all surface moisture has been removed can be accomplished by, for example, subjecting the carbon source material to the heated air at a given temperature or temperature range for a duration or duration range known to eliminate most or all surface moisture, analyzing the mixture of gases in or exiting the pulverizer 104 to determine the ratio of heated air to water vapor, using another means of determining the amount of moisture in a gaseous mixture, or some combination thereof. In one embodiment, the carbon source may be subjected to heated air at a temperature of at least 100° C. for a duration between 1-30 minutes. In another embodiment, the carbon source material may be subjected to the heated air or inert gas at a temperature between 100-350° C. for a duration between 1-30 minutes. The carbon source material, following particle size reduction and drying, defines a pulverized carbon source material. In one embodiment, the pulverized carbon source material has less than or equal to 5% moisture by weight after pulverization and drying. In an alternate embodiment, the pulverized carbon source material has less than or equal to 2% moisture by weight after pulverization and drying.

The heated air, water vapor, and pulverized carbon source material are then subjected to optional cyclone 112 whereat the heated air and the water vapor are separated from the pulverized carbon source material. In one embodiment, greater than or equal to 90% by weight of the heated air and the water vapor are removed. In an alternate embodiment, greater than or equal to 95% by weight of the heated air and the water vapor are removed. In addition to removing air and water from the pulverized carbon source material, the optional cyclone 112 may act as a pneumatic transporter used to move material through the system 100, 200.

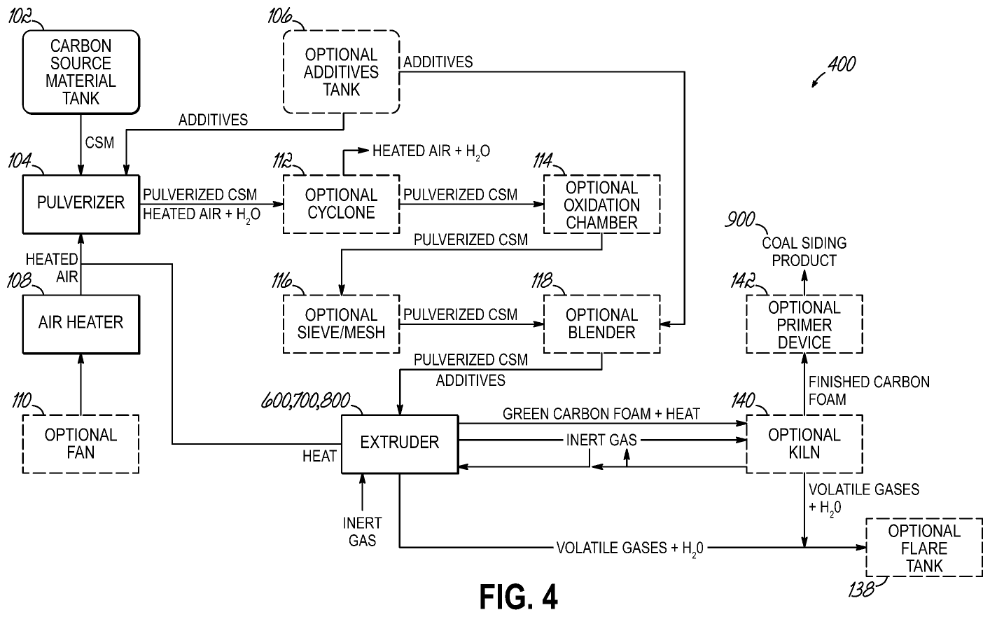

With reference to FIGS. 1 and 4, following the optional cyclone 112, the pulverized carbon source material may then be subjected to an optional oxidation chamber 114 configured to receive the pulverized carbon source material. The optional oxidation chamber 114 may be configured to receive the pulverized carbon source material from one or more of the group consisting of the pulverizer 104 and the optional cyclone 112. In one embodiment, the optional oxidation chamber 114 may be configured to oxidize the carbon source material via contact with a gaseous oxidizer such as, for example, air, oxygen, alternative gaseous oxidizing agent, or mixtures thereof. In another embodiment, the optional oxidation chamber 114 may be configured to oxidize the carbon source material via contact with a liquid or aqueous oxidizing agents such as, for example, acid, hydrogen peroxide, other liquid or aqueous oxidizers, or mixtures thereof. The pulverized carbon source material may be oxidized at temperatures up to 350° C. introducing and/or increasing oxygen functionality (e.g., R*, ROOH, RO* functional groups) of the carbon's surface. In one embodiment, the carbon source material is maintained in contact with the oxidizer within the optional oxidation chamber 114 for less than or equal to 200 hours. In an alternate embodiment, the carbon source material is maintained in contact with the oxidizer within the optional oxidation chamber 114 for less than or equal to 24 hours. In yet another alternate embodiment, the carbon source material is maintained in contact with the oxidizer within the optional oxidation chamber 114 for less than or equal to 1 min.

With further reference to FIGS. 1 and 4, following the optional oxidation chamber 114, the pulverized carbon source material may then be subjected to one or more optional sieves 116 configured to receive the pulverized carbon source material. The one or more optional sieves 116 may be configured to receive the pulverized carbon source material from one or more of the group consisting of the pulverizer 104, the optional cyclone 112, and the optional oxidation chamber 114. The one or more optional sieves 116 may be configured to select a size or size range for the pulverized carbon source material prior to entering the float bath 300 and/or the extruder 600, 700, 800 (discussed further below). In one embodiment, the one or more sieves 116 includes at least two sieves having different sized mesh openings used in series to select for a range of particle sizes for the pulverized carbon source material by selecting particles both having a size smaller than the larger mesh openings and having a size larger than the smaller mesh openings. In one embodiment, a first mesh (not shown) having a mesh size is used to select the size of the carbon source material entering the carbon source material tank, wherein the first mesh size may be selected from the list consisting of an 80M size, a 35M size, and a 14M size. In a further embodiment thereof, a second mesh (not shown) having a second mesh size is used thereafter, wherein the second mesh size may be selected from the list consisting of a 35M size and a 80M size. In one embodiment, particle sizes of pulverized carbon source material entering may range from 1-1,000 μm. In an alternate embodiment, particle sizes of pulverized carbon source material entering may range from 1-500 μm. In yet another alternate embodiment, particle sizes of pulverized carbon source material entering may range from 1-100 μm. In still another alternate embodiment, particle sizes of the pulverized carbon source material may range from 1-18 μm, which may include carbon dust.

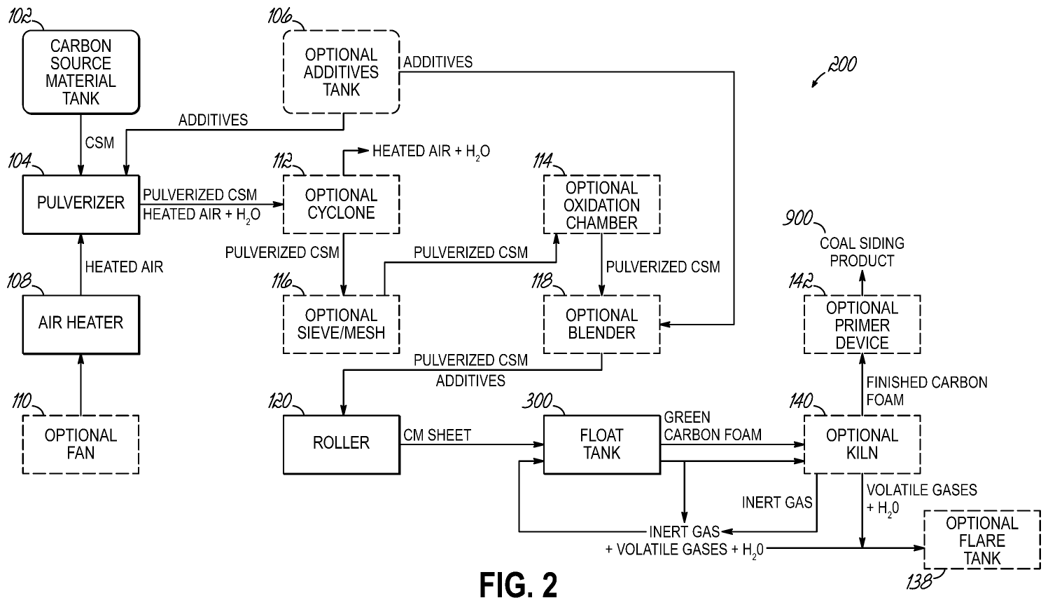

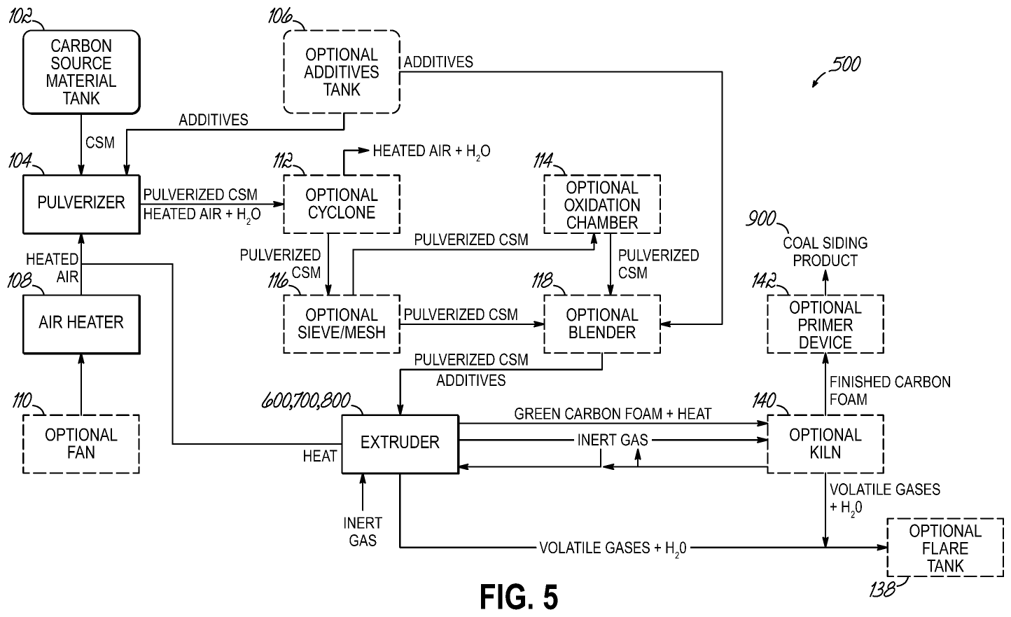

With reference to FIGS. 2 and 5, the order of the optional oxidation chamber 114 and the one or more optional sieves 116 may be reversed, such that the one or more optional sieves 116 are situated before the optional oxidation chamber 114. The one or more optional sieves 116 in such embodiments may be configured to receive the pulverized carbon source material from one or more of the group consisting of the pulverizer 104 and the optional cyclone 112. The optional oxidation chamber 114 may be configured to receive the pulverized carbon source material from one or more of the group consisting of the pulverizer 104, the optional cyclone 112, and the one or more optional sieves 116.

With reference to FIGS. 1-2 and 4-5, following the optional oxidation chamber 114 and/or the one or more optional sieves 116, the pulverized carbon source material may then be subjected to an optional blender 118 configured to receive the pulverized carbon source material. The optional blender 118 may be configured to receive the pulverized carbon source material from one or more of the group consisting of the pulverizer 104, the optional cyclone 112, the optional oxidation chamber 114, and the one or more optional sieves 116. In one embodiment, the optional blender 118 is further configured to receive the one or more additives from the optional additives tank 106. The optional blender 118 may be configured to mix the pulverized carbon source material and the one or more additives prior to the roller 120 (discussed further below with respect to FIGS. 1-3) or prior to the extruder 600, 700, 800 (discussed further below with respect to FIGS. 4-6).

In one embodiment, the optional additives tank 106 is configured to send the one or more additives to only the pulverizer 104. In another embodiment, the optional additives tank 106 is configured to send the one or more additives discussed above to only the optional blender 118. In another embodiment, the optional additives tank 106 is configured to send the one or more additives to both the pulverizer 104 and the optional blender 118. In a further embodiment thereof, the optional additives tank 106 is configured to send different additives to the pulverizer 104 and the optional blender 118.

With respect to FIGS. 1 and 2, following the optional blender 118, the pulverized carbon source material may then be subjected to a roller 120 configured to receive the pulverized carbon source material. In one embodiment, the roller 120 may be replaced with another flattening device such as, for example, a plate press. The roller 120 may be configured to receive the pulverized carbon source material from one or more of the group consisting of the pulverizer 104, the optional cyclone 112, the optional oxidation chamber 114, the one or more optional sieves 116, and the optional blender 118. The roller 120 may be configured to flatten the pulverized carbon source material, with or without the one or more additives, into a carbon material sheet prior to the float bath 300 (discussed further below). In one embodiment, the roller 120 includes one or more cylinder configured to receive the pulverized carbon material and compress the pulverized carbon source material, with or without the one or more additives, into a carbon material sheet. The one or more cylinder may also pull or push the received carbon source material towards the float bath 300 (discussed further below). Optionally, the one or more cylinders may be configured to vibrate in a manner that enhances the compression of the pulverized carbon source material, with or without the one or more additives, into a carbon material sheet.

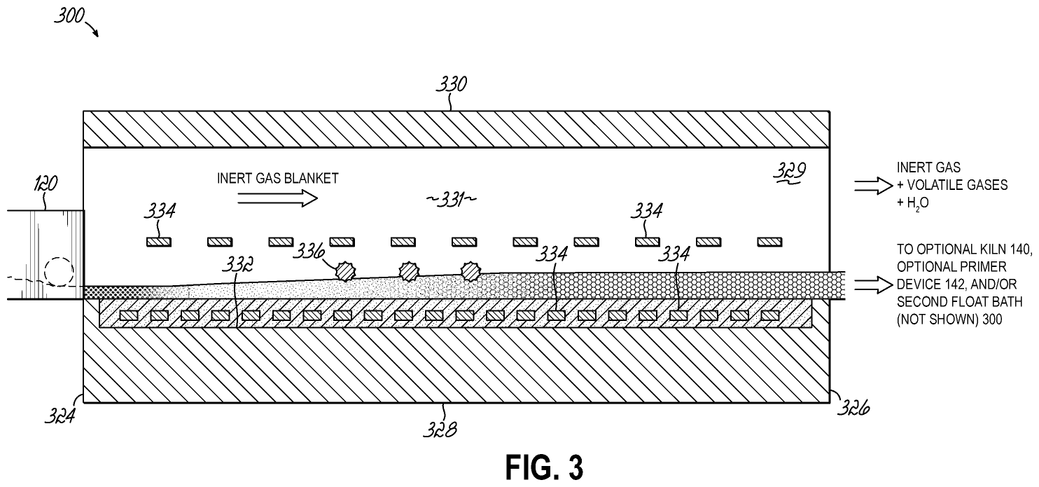

Following the roller 120, the pulverized carbon source material is then subjected to the float bath 300 for further processing. With reference to FIG. 3, the float bath 300 has a first end 324 and a second end 326, such that the first end 324 is configured to receive the carbon material sheet from the roller 120 and the float bath 300 is configured to convey the carbon material sheet toward the second end 326. The float bath 300 further includes a float bath bottom 328, float bath walls 329 (one of the float bath wall 329 is not shown in the cross-sectional view of FIG. 3), and a float bath top 330 separated from the float bath bottom 328 and connected by the float bath walls to define a float bath chamber 331. The float bath bottom 328 includes a cavity between the first end 324 and the second end 326 that defines a molten metal container 332 that is configured to receive and contain a molten metal such that the carbon material sheet is received by the molten metal before reaching the second end 326. The float bath 300 further includes a plurality of heating elements 334, such that at least one heating element 334 is positioned within the molten metal container 332 and at least one heating element 334 is positioned between the top of the molten metal container 332 and the float bath top 330. The float bath 300 may further comprise one or more optional product pullers 336 configured to enable or enhance conveyance of the carbon material sheet received from the roller 120 towards the second end 326. In one embodiment, the float bath 300 is configured for continuous production of a green carbon foam from the carbon material sheet.

The plurality of heating elements 334 are configured to heat a metal to or past the melting point of the metal to define a molten metal that is received within the molten metal container 332. In one embodiment, the plurality of heating elements 334 are configured to maintain the temperature of at least one of the molten metal and/or the float bath 300 between 380-500° C. In an alternate embodiment, the plurality of heating elements 334 are configured to maintain the temperature of at least one of the molten metal and/or the float bath 300 between 420-450° C. Accordingly, the metal used as the molten metal received in the molten metal container 332 may be selected, at least in part, based on the melting point of the metal. In one embodiment, the molten metal may include, for example, zinc, lead, cadmium, tin, other metals with suitable melting points, alloys thereof, or combination thereof.

Depending on the embodiment, the plurality of heating elements 334 may be used to heat the pulverized carbon and any additives to a temperature or temperature range based on Gieseler fluidity properties of the carbon source material used. In one such embodiment, the plurality of heating elements 334 might be used to maintain the temperature above a softening temperature, alternatively at least 10° C. above the softening temperature, still alternatively at least 20° C. above the softening temperature, or yet further alternatively at least 30° C. above the softening temperature. Without being bound by theory, it is believed that failure to maintain the temperature of the pulverized carbon and any additive above the softening temperature may lead to premature hardening or setting of the pulverized carbon material within the float bath 300.

In an alternate embodiment, the plurality of heating elements 334 may be used to maintain the temperature of the pulverized carbon and any additives below a solidification temperature of the carbon source material used, alternatively at least 10° C. below the solidification temperature, still alternatively at least 20° C. below the solidification temperature, or yet further alternatively at least 30° C. below the solidification temperature. Without being bound by theory, it is believed that failure to maintain the temperature of the pulverized carbon and any additive below the softening temperature of the carbon source material used may prevent formation of a foam structure within the float bath 300. Alternatively, the float bath can be operated at a temperature approaching the solidification temperature. Further, the float bath can be operated at a temperature 10° C. above the solidification temperature.

In another alternate embodiment, the plurality of heating elements 334 may be used to maintain the temperature of the pulverized carbon and any additives above a softening temperature of the carbon source material used and below a solidification temperature of the carbon source material used. In one such embodiment, the plurality of heating elements 334 may be used to maintain the temperature above the softening temperature and below the solidification temperature, or alternatively above the softening temperature and at least 10° C. below the solidification temperature, still alternatively above the softening temperature and at least 20° C. below the solidification temperature, or yet further alternatively above the softening temperature and at least 30° C. below the solidification temperature. In another such embodiment, the plurality of heating elements 334 may be used to maintain the temperature at least 10° C. above the softening temperature and below the solidification temperature, alternatively at least 20° C. above the softening temperature and below the solidification temperature, or still alternatively at least above 30° C. above the softening temperature and below the solidification temperature. In yet another embodiment, the plurality of heating elements 334 may be used to maintain the temperature at least 10° C. above the softening temperature and at least 10° C. below the solidification temperature, alternatively at least 20° C. above the softening temperature and at least 20° C. below the solidification temperature, or still alternatively at least 30° C. above the softening temperature and at least 30° C. below the solidification temperature.

Generally speaking, the float bath 300 functions by having the carbon material sheet float across the molten metal from the first end 324 to the second end 326. In order for the carbon material sheet to float across the molten metal, the density of the molten metal must exceed the density of the carbon material sheet. Accordingly, the metal used as the molten metal received in the molten metal container 332 may be selected, at least in part, based on the density of the molten metal. In one embodiment, the molten metal may include, for example, zinc, lead, cadmium, tin, other metals with suitable densities, alloys thereof, or combination thereof. As the carbon material sheet floats across the molten metal, the carbon material sheet is heated in the presence of an inert gas to promote pyrolysis of the carbon material sheet. During this heating process, the carbon material sheet may soften and become a fluid. In one embodiment, the pulverized carbon becomes a fluid when it is heated and serves as a lubricant for the composite material formulation. The inert gas may include, for example, nitrogen gas, helium gas, argon gas, neon gas, carbon dioxide, steam, or some combination thereof. In one embodiment, the inert gas fills a majority of the open space within the float bath chamber 331. In a further embodiment, the inert gas is flowed through the float bath chamber 331 such that the gas enters the float bath chamber 331 at or near the first end 324 towards the second end 326. In an even further embodiment, the inert gas is collected at or near the second end 326. In a yet further embodiment, the inert gas collected at or near the second end 326 and is recycled back to or near the first end 324.

Subjecting the carbon material sheet, which may include a composite formulation in embodiments including one or more additives as discussed above, to the elevated temperatures may also serve other functions such as, for example, release of volatile organic components (VOCs) from the carbon material sheet into the float bath chamber 331, further drying the carbon material sheet (e.g., release of water vapor into the float bath chamber 331), or some combination thereof. The elevated temperature of the float bath 300 causes the carbon material sheet to foam as one or more volatile gases are released from the composite material formulation during extrusion, resulting in a green carbon foam. In one embodiment, the green carbon foam formed is a cellular foam. These released volatile gases may be the result of at least one of VOCs being released from the pulverized carbon source material and/or from a chemical foaming agent additive. In one embodiment where the elevated temperatures cause release of the VOCs within the carbon material sheet, at least one volatile gas is produced in the float bath chamber 331 and collected at or near the second end 326. The at least one volatile gas may include, for example, carbon dioxide, one or more gases originating from the chemical foaming agent, some other volatile gas, or a combination thereof. In one embodiment where the elevated temperatures cause further drying of the carbon material sheet, water vapor is produced in the float bath chamber 331 and collected at or near the second end 326. In a further embodiment, the elevated temperature causes both release of the VOCs and further drying of the pulverized carbon source material such that at least one volatile gas and water vapor are produced in the float bath chamber 331 and subsequently collected at or near second end 326. When at least one volatile gas, water vapor, or both are produced during heating of the carbon material sheet, the at least one volatile gas and/or water vapor may be collected along with the inert gas at or near the second end 326. In a further embodiment, the inert gas is separated from the volatile gases and/or the water vapor and is recycled back to the first end 324. In an even further embodiment, at least one of the volatile gases and the water vapor separated from the inert gas is collected at one or more optional flare tank 138 (see FIGS. 1-2).

The rate at which the green carbon foam exits the float bath 300 at or near the second end 326 may depend in part on a pulling process implemented using the one or more product pullers 336. The one or more product pullers 336 may include, for example, a gear wheel, a roller, a belt, mesh, some other similar device, or some combination thereof. In one embodiment, one or more of the product pullers 336 may be configured to pull at least one of the carbon sheet material, the fluid carbon, and the green carbon foam in the direction generally from the first end 324 towards the second end 326. In a further embodiment, all of the one or more product pullers 336 may be configured to pull only the carbon sheet material and/or the fluid carbon such that the shape of the resulting green carbon foam is less impacted by interfacing with the one or more product pullers 336.

The float bath 300 may be capable of shaping the green carbon foam to have a desired width and/or a desired thickness. The width of the green carbon foam may be determined at least in part by the width of the carbon material sheet entered into the float bath 300. In one embodiment, one or more of the product pullers 336 may be configured to adjust the width of the green carbon foam to have a width greater than the width of the carbon material sheet by pulling at least one of the carbon material sheet, the fluid carbon, and the green carbon foam in a direction substantially perpendicular to the direction from the first end 324 to the second end 326 toward the float chamber walls 329. In a further embodiment, shaping the green carbon foam to have a width greater than the carbon material sheet may also decrease the thickness of the green carbon foam. In another embodiment, one or more of the product pullers 336 may be configured to adjust the width of the green carbon foam to have a width less than the width of the carbon material sheet by pulling at least one of the carbon material sheet, the fluid carbon, and the green carbon foam in a direction substantially perpendicular to the direction from the first end 324 to the second end 326 away from the float chamber walls 329 (i.e., towards a center of the float bath chamber 331 along the plane including at least one of the carbon material sheet, fluid carbon, and green carbon foam). In a further embodiment, shaping the green carbon foam to have a width less than the carbon material sheet may also increase the thickness of the green carbon foam. In one embodiment, the green carbon foam produced at the float bath 300 has a width of approximately 12 feet. In one embodiment, the green carbon foam formed by the float bath 300 has a density less than or equal to 1000 kg/m³. In an alternate embodiment, the green carbon foam formed by the float bath 300 has a density less than or equal to 500 kg/m³. In yet another alternate embodiment, the green carbon foam formed by the float bath 300 has a density less than or equal to 400 kg/m³. In still another alternate embodiment, the green carbon foam formed by the float bath 300 has a density less than or equal to 300 kg/m³.

Although a single float bath 300 is shown, it should be understood that a greater plurality of float baths 300 may be used such as, for example, in series or in parallel (not shown). In an embodiment where a plurality of float baths are used in series, the plurality of heating elements 334 may be configured to heat the molten metal first float bath, and thereby heat the pulverized carbon source material and any additives, to a first temperature and the molten metal within second float bath, and thereby the pulverized carbon source material and any additives, to a second temperature. In one embodiment, the first temperature and second temperature are defined with reference to the Gieseler fluidity properties of the carbon source material used such as, for example, the maximum fluidity temperature and/or the solidification temperature.

In a one such embodiment, the first temperature is approximately equal to the maximum fluidity temperature of the carbon source material used, alternatively greater than or equal to 5° C. below the maximum fluidity temperature and less than or equal to 5° C. above the maximum fluidity temperature, still alternatively greater than or equal to 10° C. below the maximum fluidity temperature and less than or equal to 10° C. above the maximum fluidity temperature, or yet further alternatively greater than or equal to 20° C. below the maximum fluidity temperature and less than or equal to 20° C. above the maximum fluidity temperature. Without being bound by theory, it is believed that heating the pulverized carbon and any additives within a first float bath to a first temperature as set out above results in improved expansion and foam formation prior to subsequent solidification at, near, or in the second float bath due at least in part to increased liquidity of the pulverized carbon and any additives within the first float bath.

In another such embodiment, the second temperature is greater than the maximum fluidity temperature of the carbon source material used and less than the solidification temperature of the carbon source material used. In an alternate embodiment, the second temperature is greater than the maximum fluidity temperature and at least 5° C. less than the solidification temperature, alternatively greater than the maximum fluidity temperature and at least 10° C. less than the solidification temperature, still alternatively greater than the maximum fluidity temperature and at least 20° C. less than the solidification temperature, or yet further alternatively greater than the maximum fluidity temperature and at least 30° C. less than the solidification temperature of the carbon source material used. In another alternate embodiment, the second temperature is at least 5° C. greater than the maximum fluidity temperature and less than the solidification temperature, alternatively at least 10° C. greater than the maximum fluidity temperature and less than the solidification temperature, or still alternatively at least 20° C. greater than the maximum fluidity temperature and less than the solidification temperature of the carbon source material used. In yet another alternate embodiment, the second temperature is at least 5° C. greater than the maximum fluidity temperature and at least 5° C. less than the solidification temperature, alternatively at least 10° C. greater than the maximum fluidity temperature and at least 10° C. less than the solidification temperature, still alternatively at least 20° C. greater than the maximum fluidity temperature and at least 20° C. less than the solidification temperature, or still alternatively at least 30° C. greater than the maximum fluidity temperature and at least 30° C. less than the solidification temperature of the carbon source material used. Without being bound by theory, it is believed that heating the pulverized carbon and any additives within a second float bath to a second temperature as set out above (in combination with heating the pulverized carbon and any additives within a first float bath to a first temperature as set out above) improves the resulting green carbon foam at least in part by hardening the pulverized carbon and any additives after the resulting expansion and/or foaming within the first float bath.

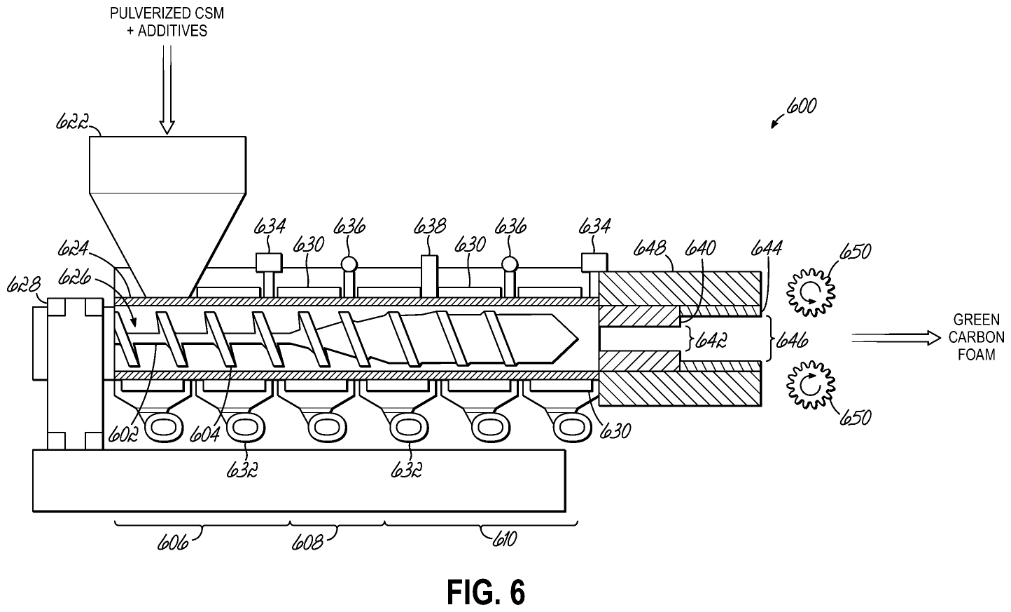

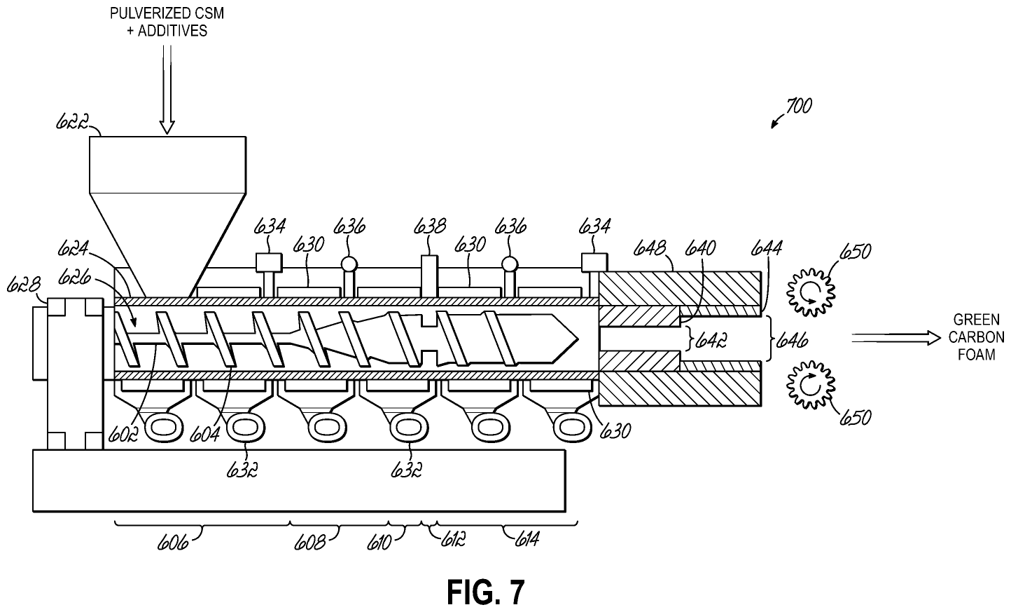

With reference to FIGS. 4 and 5, following the optional blender 118, the pulverized carbon source material may then be subjected to an extruder 600, 700, 800 for further processing. The extruder 600, 700, 800 may be configured for continuous production of a green carbon foam from the pulverized carbon source material. With reference to FIGS. 6-7, extruder 600, 700 has a feed hopper 622 configured to receive the pulverized carbon source material and configured to permit entry of materials received into a barrel 624. The barrel 624 includes an auger 626 that is coupled to a motor 628, wherein the motor 628 is configured to rotate the auger 626. The auger 626 is configured to convey the pulverized carbon source material received from the feed hopper 622 toward a die 648 when rotated by the motor 628.

With continued reference to FIGS. 6 and 7, the extruder 600, 700 includes a plurality of heating elements 630 that are configured to heat the barrel 624 and the pulverized carbon source material as it travels therethrough. In one embodiment, the extruder 600, 700 includes one or more optional cooling fans 632 that are configured to remove heat from the barrel 624 and the pulverized carbon source material as it travels therethrough. In one embodiment, the extruder 600, 700 includes one or more optional sensor such as, for example, an optional pressure transducer 634 configured to determine the pressure within the extruder 600, 700, an optional thermocouple 636 configured to determine the temperature within the extruder 600, 700, an optical sensor (e.g., Raman, IR, etc.), another similar sensor, or some combination thereof. In one embodiment, the extruder 600, 700 includes an optional vent 638 that is configured to reduce pressure within the barrel 624 when opened. In one embodiment, the extruder 600, 700 includes the die 648 configured to shape the green carbon foam as it exits the extruder 600, 700. In one embodiment, one or more pullers 650 configured to enable or enhance conveyance of a green carbon foam away from the extruder 600, 700 may be positioned downstream from the die 648. In one embodiment, the extruder 600, 700 includes more than one component selected from the list consisting of the one or more optional cooling fans 632, the one or more optional pressure transducer 634, the one or more optional thermocouple 636, the optional vent 638, and the one or more optional pullers 650. In an alternate embodiment, the extruder 600, 700 includes one or more cooling fan 632, one or more pressure transducer 634, one or more thermocouple 636, a vent 638, and one or more puller 650.

In embodiments including the optional vent 638, volatile gas(es) removed from the extruder 600, 700, 800 when the optional vent 638 is opened may be sent to the flare tank 138. Alternatively, volatile gas(es) removed from the extruder 600, 700, 800 when the optional vent 638 is opened could be sent to a separate collection tank (not shown). In such an embodiment, the volatile gas(es) collected in the separate collection tank can be cooled to collect condensable hydrocarbons. In a further embodiment, any incondensable hydrocarbons collected in the separate collection tank (not shown) can be removed therefrom and sent to the flare tank 138.

Generally speaking, the extruder 600, 700 functions by receiving pulverized carbon source material and any additives at the feed hopper 622, conveying the pulverized carbon source material and any additives through the barrel 624 downstream towards the die 648, and extruding the green carbon foam at or after the one or more die 648. While conveying the pulverized carbon source material and any additives through the barrel 624, the one or more heating elements 630 are configured to heat the pulverized carbon source material. Portions of the barrel 624 may be substantially free of oxygen, allowing for pyrolysis of the pulverized carbon source material when heated. In one such embodiment, an inert gas is flowed through the extruder 600, 700 along with the pulverized carbon source material. The inert gas may include, for example, nitrogen gas, helium gas, argon gas, neon gas, carbon dioxide, steam, or some combination thereof. In one embodiment, the inert gas is flowed through the extruder 600, 700 such that the inert gas enters the extruder 600, 700 at or near the feed hopper 622 and is flowed towards the die 648 together with the pulverized carbon source material. In an even further embodiment, the inert gas is collected at or near the die 648. In a yet further embodiment, the inert gas collected at or near the die 648 and is recycled back to or near the feed hopper 622. In an alternate further embodiment, the inert gas is collected at or near the die 648 and is flowed towards the optional kiln 140 (discussed further below).

As shown, the feed hopper 622 is tapered such that the point of entry into the barrel 624 is smaller than the point of entry into the feed hopper 622. It should be understood that this is a non-limiting example of the shape of the feed hopper 622, and that other embodiments of the invention may include a feed hopper having another shape. The feed hopper 622 may be configured to control the rate at which materials, such as the pulverized carbon source material, enter the barrel 624. In one embodiment, the feed hopper 622 may include an optional gating component (not shown) configured to open and close entry to the barrel 624. In an alternate embodiment, the feed hopper 622 includes an optional feed auger (not shown) configured to deposit materials, such as the pulverized carbon source material and any additives, into the barrel 624 at an adjustable rate. The feed hopper 622 may be configured to mix materials received, such as the pulverized carbon source material, prior to entry into the barrel 624. In one such embodiment, the feed hopper 622 includes an optional agitator (not shown).

As shown FIGS. 6 and 7, the barrel 624 may be a cylinder that has a length and an inner diameter configured to receive the auger 626. The auger 626 has a shaft 602 and a flighting portion 604 extending radially from the shaft 602 toward the barrel 624 that spirals along at least a portion of the length of the shaft 602 to define a flighting length. In one embodiment, the diameter of the flighting portion 604 (i.e., the flight diameter) is selected to minimize the gap between the flighting portion and the inner diameter of the barrel 624.

The shaft 602 of the auger 626 may have a diameter that varies across the length of the shaft 602. With reference to FIG. 6, the auger 626 is a single stage auger wherein the shaft 602 has three portions: a first portion 606 proximate the feed hopper 622; a second portion 608 immediately downstream from the first portion 606; and a third portion 610 immediately downstream from the second portion 608. As shown in FIG. 6, the third portion 610 is proximate the die 648. In one embodiment, the first portion 606 has a diameter smaller than the diameter of the third portion 610, whereas the second portion 608 has an increasing diameter along the length beginning at the end of the first portion 606 and ending at the beginning of the third portion 610.

With reference to FIG. 7, the auger 626 is a two-stage auger wherein the shaft 602 has five portions: the first portion 606 proximate the feed hopper 622; the second portion 608 immediately downstream from the first portion 606; the third portion 610 immediately downstream from the second portion 608; a fourth portion 612 immediately downstream from the third portion 610; and a fifth portion 614 immediately downstream from the fourth portion 612. As shown in FIG. 7, the fifth portion 614 is proximate the die 648. In one embodiment, the first portion 606 has a diameter smaller than the diameter of the third portion 610, whereas the second portion 608 has an increasing diameter along the length beginning at the end of the first portion 606 and ending at the beginning of the third portion 610. In one embodiment, the third portion 610 has a diameter equal to or nearly equal to the diameter of the fifth portion 614, whereas the fourth portion 612 connecting the two has a smaller diameter. In a further embodiment, the vent 638 is positioned directly above the fourth portion 612.

With continued reference to FIGS. 6 and 7, it should be understood that the invention is not limited to augers 626 as shown in FIGS. 6 and 7. In one such embodiment, the extruder 600, 700 may include an auger 626 having a uniform shaft diameter (not shown). It should also be understood that the invention is not limited to embodiments having only a single auger 626. For example, the extruder 600, 700 may include a plurality of augers (not shown) such as, for example, a counter rotating twin screw extruder, a co-rotating twin screw extruder, a cascade extruder having a plurality of augers in series, or some combination thereof. The barrel 624 and/or the auger 626 may be selected, at least in part, based on the ratio of the length to diameter (i.e., an L/D ratio), wherein the length corresponds to the length of the auger 626 having the flighted portion and the diameter corresponds to the diameter of the flighted portion. In one embodiment, the L/D ratio of the barrel 624 and/or the auger 626 is greater than or equal to 10:1 and less than or equal to 40:1. In an alternate embodiment, the L/D ratio of the barrel 624 and/or the auger 626 is greater than or equal to 20:1 and less than or equal to 24:1. In another alternate embodiment, the L/D ratio of the barrel 624 and or the auger 626 is greater than or equal to 30:1 and less than or equal to 40:1.

The plurality of heating elements 630 may be configured to heat the pulverized carbon to a threshold temperature necessary to form the green carbon foam when extruded. In one such embodiment, the plurality of heating elements 630 are configured to maintain the temperature of the pulverized carbon and any additives between 380-500° C. In an alternate embodiment, the plurality of heating elements 630 are configured to maintain the temperature of the pulverized carbon and any additives between 420-450° C. Heating the pulverized carbon source material may cause or contribute to plasticizing the pulverized carbon source material within the barrel 624. In one embodiment, the pulverized carbon source material may become a fluid during conveyance toward the die 648. The extruder 600, 700 may optionally include one or more cooling fan 632 that are configured to regulate the temperature within the barrel 624 by removing excess heat from the system. In one such embodiment, the one or more cooling fan 632 is configured to remove heat based on one or more of the thermocouples 636 reaching a threshold temperature. The one or more cooling fans 632 may be used to recycle heat to other parts of the system 400, 500 such as, for example, the pulverizer 104 and/or the optional kiln 140 (discussed further below). In an alternate embodiment, the optional one or more cooling fan 632 may be replaced with a water cooling system (not shown).

Depending on the embodiment, the plurality of heating elements 630 may be used to heat the pulverized carbon and any additives to a temperature or temperature range based on Gieseler fluidity properties of the carbon source material used. In one such embodiment, the plurality of heating elements 630 might be used to maintain the temperature above a softening temperature, alternatively at least 10° C. above the softening temperature, still alternatively at least 20° C. above the softening temperature, or yet further alternatively at least 30° C. above the softening temperature. Without being bound by theory, it is believed that failure to maintain the temperature of the pulverized carbon and any additive above the softening temperature of the carbon source material used may lead to premature hardening or setting of the pulverized carbon material within the extruder 600, 700, thereby reducing or preventing the extrudability of the green carbon foam.

In an alternate embodiment, the plurality of heating elements 630 and optionally the one or more cooling fan 632 may be used to maintain the temperature of the pulverized carbon and any additives below a solidification temperature of the carbon source material used, alternatively at least 10° C. below the solidification temperature, still alternatively at least 20° C. below the solidification temperature, or yet further alternatively at least 30° C. below the solidification temperature. Without being bound by theory, it is believed that failure to maintain the temperature of the pulverized carbon and any additive below the solidification temperature of the carbon source material used may lead to premature hardening or setting of the pulverized carbon material within the extruder 600, 700, thereby reducing or preventing the extrudability of the green carbon foam.

In another alternate embodiment, the plurality of heating elements 630 and optionally the one or more cooling fan 632 may be used to maintain the temperature of the pulverized carbon and any additives above a softening temperature of the carbon source material used and below a solidification temperature of the carbon source material used. In one such embodiment, the plurality of heating elements 630 and optionally the one or more cooling fan 632 may be used to maintain the temperature above the softening temperature and below the solidification temperature, or alternatively above the softening temperature and at least 10° C. below the solidification temperature, still alternatively above the softening temperature and at least 20° C. below the solidification temperature, or yet further alternatively above the softening temperature and at least 30° C. below the solidification temperature. In another such embodiment, the plurality of heating elements 630 and optionally the one or more cooling fan 632 may be used to maintain the temperature at least 10° C. above the softening temperature and below the solidification temperature, alternatively at least 20° C. above the softening temperature and below the solidification temperature, or still alternatively at least 30° C. above the softening temperature and below the solidification temperature. In yet another embodiment, the plurality of heating elements 630 and optionally the one or more cooling fan 632 may be used to maintain the temperature at least 10° C. above the softening temperature and at least 10° C. below the solidification temperature, alternatively at least 10° C. above the softening temperature and at least 20° C. below the solidification temperature, still alternatively at least 20° C. above the softening temperature and at least 20° C. below the solidification temperature, or yet further alternatively at least 30° C. above the softening temperature and at least 30° C. below the solidification temperature.

With reference to FIG. 7, the pulverized carbon material and any additives within different portions of the barrel 624 (corresponding to portions of the shaft 602 enumerated above) may be maintained at different temperatures in different portions using the plurality of heating elements 630 and optionally the one or more cooling fan 632. In one such embodiment, the pulverized carbon and any additives adjacent to the third portion 610 are heated to a first temperature whereas the pulverized carbon and any additives adjacent to the fifth portion 614 are heated to a second temperature. In one embodiment, the first temperature and second temperature are defined with reference to the Gieseler fluidity properties of the carbon source material used such as, for example, the maximum fluidity temperature and/or the solidification temperature.

In a one such embodiment, the first temperature is approximately equal to the maximum fluidity temperature of the carbon source material used, alternatively greater than or equal to 5° C. below the maximum fluidity temperature and less than or equal to 5° C. above the maximum fluidity temperature, still alternatively greater than or equal to 10° C. below the maximum fluidity temperature and less than or equal to 10° C. above the maximum fluidity temperature, yet further alternatively greater than or equal to 20° C. below the maximum fluidity temperature and less than or equal to 20° C. above the maximum fluidity temperature, or even further alternatively greater than or equal to 30° C. below the maximum fluidity temperature and less than or equal to 30° C. above the maximum fluidity temperature. Without being bound by theory, it is believed that heating the pulverized carbon and any additives adjacent to the third portion 610 to a first temperature as set out above results in improved expansion and foam formation adjacent to the fourth portion 612 due at least in part to increased liquidity of the pulverized carbon and any additives within the third portion 610 and at least in part to the difference in shaft 602 diameters between the third portion 610 and the fourth portion 612.

In another such embodiment, the second temperature is greater than the maximum fluidity temperature of the carbon source material used and less than the solidification temperature of the carbon source material used. In an alternate embodiment, the second temperature is greater than the maximum fluidity temperature and at least 5° C. less than the solidification temperature, alternatively greater than the maximum fluidity temperature and at least 10° C. less than the solidification temperature, still alternatively greater than the maximum fluidity temperature and at least 20° C. less than the solidification temperature, or yet further alternatively greater than the maximum fluidity temperature and at least 30° C. less than the solidification temperature of the carbon source material used. In another alternate embodiment, the second temperature is at least 5° C. greater than the maximum fluidity temperature and less than the solidification temperature, alternatively at least 10° C. greater than the maximum fluidity temperature and less than the solidification temperature, still alternatively at least 20° C. greater than the maximum fluidity temperature and less than the solidification temperature, or yet further alternatively at least 30° C. greater than the maximum fluidity temperature and less than the solidification temperature of the carbon source material used. In yet another alternate embodiment, the second temperature is at least 5° C. greater than the maximum fluidity temperature and at least 5° C. less than the solidification temperature, alternatively at least 10° C. greater than the maximum fluidity temperature and at least 10° C. less than the solidification temperature, still alternatively at least 20° C. greater than the maximum fluidity temperature and at least 20° C. less than the solidification temperature, or yet further alternatively at least 30° C. greater than the maximum fluidity temperature and at least 30° C. less than the solidification temperature of the carbon source material used. Without being bound by theory, it is believed that heating the pulverized carbon and any additives adjacent to the fifth portion 614 to a second temperature as set out above (in combination with heating the pulverized carbon and any additives adjacent to the third portion 610 to a first temperature as set out above) improves the resulting green carbon foam at least in part by hardening the pulverized carbon and any additives after the resulting expansion and/or foaming adjacent to the fourth portion 612.

As shown, the die 648 includes a plurality of plates 640, 644 configured to shape the green carbon foam as it exits the extruder 600, 700. In such an embodiment, the die 648 may include a first plate 640 having a first plate opening size 642, wherein the first plate 640 is positioned upstream from a second plate 644 having a second plate opening size 646, wherein the second plate opening size 646 is larger than the first plate opening size 642. In an alternate embodiment, the die 648 may include a greater plurality of plates, and each of the plates may have a plate opening size larger than any plates upstream from it. By way of example and not limitation, the die 648 might include 3 plates, alternatively less than or equal to 5 plates, or still alternatively less than or equal to 10 plates. In another alternate embodiment, the die 648 may only have a single plate (not shown).

While within the extruder 600, 700, the elevated temperature and pressure may be sufficient to keep any volatile organic components (VOCs) dissolved within the pulverized carbon source material. In one embodiment, the elevated pressure causes or contributes to melting the pulverized carbon foam material. When the pulverized carbon source material exits through the die 648, the VOCs within the pulverized carbon source material are released as at least one volatile gas, causing the pulverized carbon source material to foam into the green carbon foam. In one embodiment, the green carbon foam formed is a cellular foam. The VOCs released to form the green carbon foam may already be present in the carbon source material or may be added thereto via an additive such as a foaming agent. The at least one volatile gas may include, for example, carbon dioxide, one or more gases originating from the chemical foaming agent, some other volatile gas, or a combination thereof. Additionally, any water present in the pulverized carbon foam may be removed as water vapor along with the volatile gas. In one embodiment, the volatile gas and any water are removed and collected at a flare 138 (discussed further below). In one embodiment, the at least one volatile gas released during extrusion is collected at a flare tank 138. In an alternate embodiment, water vapor is released during extrusion and collected at the flare tank 138. In another alternate embodiment, at least one volatile gas and water vapor are removed are released during extrusion and collected at the flare tank 138.

The shape of the green carbon foam formed in this process is at least partially dependent on a cross-sectional shape of the die 648 (not shown). The cross-sectional shape of the die 648 may be selected based on the desired shape of the green carbon foam and/or the desired cross-sectional shape of the coal product 900. In one such embodiment, the die 648 may have an annular cross-sectional shape (not shown) selected to form a green carbon foam pipe. In an alternate such embodiment, the die 648 may have a rectangular cross-sectional shape to form a sheet of foam. It should be understood that these are non-limiting examples of how the die 648 may be used to shape the resulting green carbon foam, and that a die 648 having another shape may be used depending on the end product formed. The extruder 600, 700 may be capable of shaping the green carbon foam into a sheet having a desired width and/or a desired thickness. The width of the green carbon foam sheet may be determined at least in part by the width of the cross-sectional shape of the die 648.

The rate at which the green carbon foam exits the extruder 600, 700 at or near the die 648 may depend in part on a pulling process implemented using the one or more product pullers 650. The one or more product pullers 650 may include, for example, a gear wheel, a roller, a belt, mesh, some other similar device, or some combination thereof. In one embodiment, one or more of the product pullers 650 may be configured to pull the green carbon foam in the direction generally downstream from the die 648. In one embodiment, the green carbon foam sheet produced by the extruder 600, 700 has a width of approximately 18 inches. In one embodiment, the green carbon foam sheet formed by the extruder 600, 700 has a density less than or equal to 1000 kg/m³. In an alternate embodiment, the green carbon foam formed by the extruder 600, 700 has a density less than or equal to 500 kg/m³. In yet another alternate embodiment, the green carbon foam formed by the extruder 600, 700 has a density less than or equal to 400 kg/m³. In still another alternate embodiment, the green carbon foam formed by the extruder 600, 700 has a density less than or equal to 300 kg/m³.

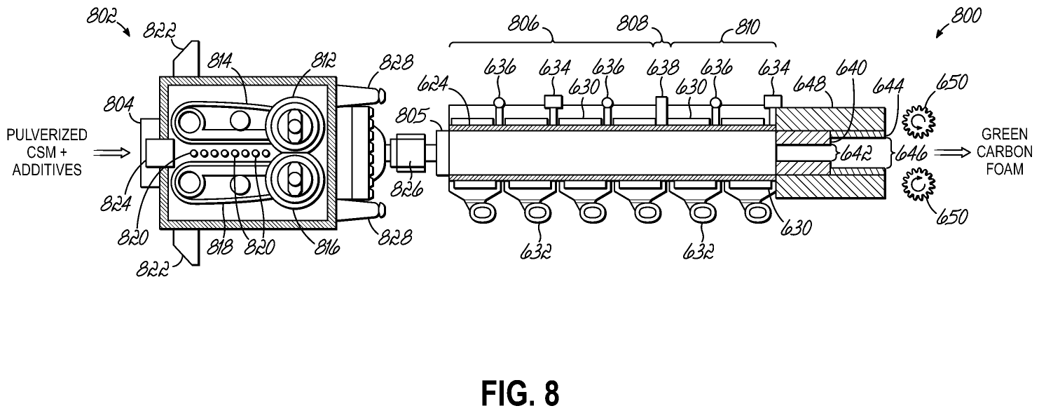

With reference to FIG. 8, an extruder 800 is disclosed using a solids pump 802 instead of an auger 626 and a motor 628 to convey the pulverized CSM and any additives through the extruder 800. Unless otherwise stated below, it should be understood that discussion and disclosure pertaining to parts having an equivalent reference numeral in FIGS. 6 and 7 apply to their counterparts in FIG. 8.

The solids pump 802 includes a pump inlet 804 and a pump outlet 805, wherein the solids pump 802 is configured to receive the pulverized carbon source material and any additives at or near the pump inlet 804 and release the pulverized carbon source material and any additives at or near the pump outlet 805. In one embodiment, the solids pump 802 may be configured to receive the pulverized carbon source material and any additives from the feed hopper 622 (not shown), alternatively the optional blender 118, still alternatively the optional sieve/mesh 116, further alternatively the optional oxidation chamber 114, yet further alternatively the optional cyclone 112, or still alternatively from the pulverizer 104.

The solids pump 812 may include a plurality of motors and a plurality of track assemblies configured to apply tractive force to the pulverized carbon source material and any additives to convey the pulverized carbon source material and any additives from the pump inlet 804 to the pump outlet 805, or alternatively through the barrel 624 to exit the extruder 800 as a green carbon foam. In one such embodiment, as shown in FIG. 8, the solids pump 802 includes a first motor 812 configured to rotate a first track assembly 814, such that when the first track assembly 814 is rotated it applies a tractive force to the pulverized carbon source material and any additives toward the barrel 624 and/or the optional kiln 140, and a second motor 816 configured to rotate a second track assembly 818, such that when the second track assembly 818 is rotated it applies a tractive force to the pulverized carbon source material and any additives toward the barrel 624 and/or the optional kiln 140. In one such embodiment, additional pulverized carbon source material and any additives entering the barrel 624 may displace the pulverized carbon source material and any additives already in the barrel 624, thereby pushing the pulverized carbon source material and any additives already in the barrel further toward the optional kiln 140. In an alternate embodiment (not shown), the solids pump 802 may only contain a single motor and track assembly configured to apply a tractive force to the pulverized carbon source material and any additives.

As shown, the first motor 812 and first track assembly 814 are configured to be located above the pulverized carbon source material and any additives, whereas the second motor 816 and the second track assembly 818 are configured to be located below the pulverized carbon source material and any additives. In such an embodiment, to ensure that the first track assembly 814 and the second track assembly 818 apply tractive forces in the same direction, the first motor 812 and the second motor 816 may be configured to rotate in opposite directions, specifically counterclockwise and clockwise respectively as shown in FIG. 8. In an alternate embodiment (not shown), the solids pump 802 can be rotated 90 degrees into the page, such that the first track assembly is located behind the pulverized carbon source material and any additives and the second track assembly is located in front of the pulverized carbon source material and any additives. In such an embodiment, to ensure that the first track assembly and the second track assembly apply tractive forces in the same direction, the first motor and second motor may be configured to rotate in opposite directions, specifically into the page and out of the page. In an embodiment

In a yet further alternate embodiments, a greater plurality of motors and corresponding track assemblies may be used. For example, a solids pump may be configured to have an even number of paired motors and track assemblies such as, for example, 4 motors and corresponding track assemblies arranged to create a pathway of track assemblies having a rectangular cross section, 6 motors and corresponding track assemblies arranged to create a pathway of track assemblies having a hexagonal cross section, 8 motors and corresponding track assemblies to create a pathway of track assemblies having an octagonal cross section, or an even greater number of motors and corresponding track assemblies. In further embodiments thereof, these solids pumps having a greater even number of motors and track assemblies may be configured to arrange these track assemblies such that each track assembly has motor rotating in a first direction and a corresponding a parallel track assembly having a motor rotating in the opposite direction such that all track assemblies apply a tractive force in the same direction, specifically toward the barrel 624 and/or the optional kiln 140. In still alternate embodiments (not shown), the solids pump 802 may contain an odd number of motors and corresponding track assemblies such that the pathway formed by the track assemblies has, for example, a triangular cross section (3 motors and track assemblies), a pentagonal cross section (5 motors and track assemblies), or an even greater odd number of motors and track assemblies. In such embodiments, each motor may have a direction of rotation determined by the effect the rotation of the motor has on the direction of the tractive force effected on the pulverized carbon and any additives by the corresponding track assembly such that all tractive forces are applied in the same direction, specifically toward the barrel 624 and/or the optional kiln 140.

The solids pump 802 may further include one or more optional component selected from the list consisting of one or more optional sensor 820, one or more optional mounting 822, an optional inlet isolation valve 824, an optional outlet isolation valve 826, one or more optional fines bin 828, or some combination thereof. In one embodiment, the solids pump 802 includes all optional components listed above. The one or more optional sensor 820 may be selected from the list consisting of an electromagnetic sensor (e.g., a microwave sensor), a temperature sensor, optic sensor, or some combination thereof. The one or more optional mounting 822 may be used to secure the position of the solids pump 802 relative to the barrel 624. The optional inlet isolation valve 824 and/or the optional outlet isolation valve 826 may be used to regulate flow of the pulverized carbon source material and any additives without subjecting the valve actuation mechanism (not shown) to the pulverized carbon source material and any additives.

With further reference to FIG. 8, the barrel 624 may be understood as having three portions: a first portion 806 proximate the solids pump 802, a second portion 808 immediately downstream from the first portion 806; and a third portion 810 immediately downstream from the second portion 808. As shown, the third portion 810 is proximate the die 648. In one embodiment, as shown in FIG. 8, the second portion 808 of the barrel 624 corresponds to the area directly below or adjacent to the vent 638.

The pulverized carbon material and any additives within different portions 806, 808, 810 of the barrel 624 may be maintained at different temperatures in different portions using the plurality of heating elements 630 and optionally the one or more cooling fan 632. In one such embodiment, the pulverized carbon and any additives adjacent to the first portion 806 are heated to a first temperature whereas the pulverized carbon and any additives adjacent to the third portion 810 are heated to a second temperature. In one embodiment, the first temperature and second temperature are defined with reference to the Gieseler fluidity properties of the carbon source material used such as, for example, the maximum fluidity temperature and/or the solidification temperature.

In a one such embodiment, the first temperature is approximately equal to the maximum fluidity temperature, alternatively greater than or equal to 5° C. below the maximum fluidity temperature and less than or equal to 5° C. above the maximum fluidity temperature, still alternatively greater than or equal to 10° C. below the maximum fluidity temperature and less than or equal to 10° C. above the maximum fluidity temperature, alternatively at least 20° C. greater than the maximum fluidity temperature and at least 20° C. less than the solidification temperature, or still further alternatively at least 30° C. greater than the maximum fluidity temperature and at least 30° C. less than the solidification temperature of the carbon source material used. Without being bound by theory, it is believed that heating the pulverized carbon and any additives adjacent to the first portion 806 to a first temperature as set out above results in improved expansion and foam formation adjacent to the second portion 808 due at least in part to increased liquidity of the pulverized carbon and any additives within the first portion 806.

In another such embodiment, the second temperature is greater than the maximum fluidity temperature and less than the solidification temperature of the carbon source material used. In an alternate embodiment, the second temperature is greater than the maximum fluidity temperature and at least 5° C. less than the solidification temperature, alternatively greater than the maximum fluidity temperature and at least 10° C. less than the solidification temperature, still alternatively greater than the maximum fluidity temperature and at least 20° C. less than the solidification temperature, or yet further alternatively greater than the maximum fluidity temperature and at least 30° C. less than the solidification temperature of the carbon source material used. In another alternate embodiment, the second temperature is at least 5° C. greater than the maximum fluidity temperature and less than the solidification temperature, alternatively at least 10° C. greater than the maximum fluidity temperature and less than the solidification temperature, or still alternatively at least 20° C. greater than the maximum fluidity temperature and less than the solidification temperature. In yet another alternate embodiment, the second temperature is at least 5° C. greater than the maximum fluidity temperature and at least 5° C. less than the solidification temperature, alternatively at least 10° C. greater than the maximum fluidity temperature and at least 10° C. less than the solidification temperature, still alternatively at least 20° C. greater than the maximum fluidity temperature and at least 20° C. less than the solidification temperature, or still further alternatively at least 30° C. greater than the maximum fluidity temperature and at least 30° C. less than the solidification temperature. Without being bound by theory, it is believed that heating the pulverized carbon and any additives adjacent to the third portion 810 to a second temperature as set out above (in combination with heating the pulverized carbon and any additives adjacent to the first portion 806 to a first temperature as set out above) improves the resulting green carbon foam at least in part by hardening the pulverized carbon and any additives after the resulting expansion and/or foaming adjacent to the second portion 808.

With continued reference to FIGS. 1-2 and FIGS. 4-5, following the float bath 300 or the extruder 600, 700, 800 respectively, the green carbon foam may then sent to the optional kiln 140 configured to receive the green carbon foam for further processing. The optional kiln 140 may be kept at an elevated temperature for further treatment of the green carbon foam. In one embodiment, the optional kiln 140 is used to vitrify the carbon foam. In such an embodiment, the optional kiln 140 is kept at an elevated temperature between 500-900° C. In another embodiment, the optional kiln 140 is used to calcinate the green carbon foam. In one such embodiment, the optional kiln 140 is kept in a controlled environment at a temperature between 500-1150° C. In an alternate such embodiment, the optional kiln 140 is kept in a controlled environment at a temperature between 900-1150° C. The controlled environment necessary for calcination may include a non-oxidizing environment such as, for example, heating in the presence of at least one inert gas such as those described above for the float bath 300. In such embodiments, the at least one inert gas may be collected after the optional kiln 140 and recycled for use at one or more of the float bath 300 and the optional kiln 140. In another embodiment, the optional kiln 140 is used to graphitize the green carbon foam. In such an embodiment, the optional kiln 140 is kept at an elevated temperature up to 3,200° C. The optional kiln 140 defines a finished foam product, which includes at least one of the vitrified foam, the calcinated foam, or the graphitized foam. In one embodiment, the finished carbon foam is cut to the desired length after at least one of the vitrification, calcination, and graphitization. In a further embodiment, the desired length is determined at least in part based on the desired length of the coal product 900.

Subjecting the green carbon foam to the elevated temperatures at the optional kiln 140 may also serve other functions such as, for example, flaring VOCs from the green carbon foam to one or more volatile gases, further drying the green carbon foam (i.e., releasing water as water vapor), other treatments of the finished foam product, or some combination thereof. In one embodiment where the elevated temperatures cause flaring of at least one of the VOCs within the finished foam product, at least one volatile gas (e.g., CO₂) is produced and collected at the one or more flare tank 138. In one embodiment where the elevated temperatures cause further drying of the finished foam product, water vapor is produced and collected at the one or more flare tank 138. In a further embodiment, the elevated temperature causes both flaring of the VOCs and further drying of the pulverized carbon source material such that at least one volatile gas and water vapor are collected in the one or more flare tank 138. In embodiments where an inert gas is used in the optional kiln 140, such as in a calcination process as described above, the inert gas may be separated from one or both of the volatile gases and/or the water vapor. In a further embodiment thereof, the inert gas may be recycled at one or more of the float bath 300 and the optional kiln 140 while at least one of the volatile gases and/or the water vapor are collected in the one or more flare tank 138. It should be understood that the one or more flare tank 138 may be the same one or more flare tank 138 tank referenced in the discussion of the float bath 300 above. However, in one embodiment, a plurality of optional flare tanks 138 may be used such that the float bath 300 and the optional kiln 140 have separate flare tanks 138 (not shown).

Following the optional kiln 140, the finished foam product is sent to an optional primer device 142 configured to receive the finished foam product for further processing. Alternatively, in embodiments not including the optional kiln 140, the green carbon foam is sent from the float bath 300 or from the extruder 600, 700, 800 to the optional primer device 142 configured to receive the green carbon foam for further processing. The optional primer device 142 is further configured to apply a coating 902 to at least one of the finished foam product or the green carbon foam. The coating 902 may include a material operable to induce or enhance certain properties in the coal product 900 such as, for example, strength, electrical conductivity, thermal conductivity, stiffness, resilience, modulus of elasticity, density, impact resistance, or some combination thereof. In one embodiment, the coating 902 includes a cementitious material configured to increase the strength of the coal product 900. The cementitious material may include, for example, Portland cement, other similar cementitious materials, or combinations thereof. In a further embodiment, applying a coating 902 including a cementitious material is followed by further thermal treatment at a temperature between 170-180° C., or alternatively at a temperature between 180-200° C. This thermal treatment of the cementitious coating layer 902 may increase adhesion of the coating to the finished foam product or the green carbon foam and/or promote expansion of the foam and cement to reduce thermal expansion mismatching. In another embodiment, the coating 902 includes a photovoltaic material that enables conversion of light to electrical current. In one embodiment, the photovoltaic material includes a material such as, for example, a perovskite, silicon (e.g., monocrystalline, polycrystalline, amorphous), gallium arsenide, some other photovoltaic, or some combination thereof. In a further embodiment, the coating 902 includes a photovoltaic perovskite selected from the group consisting of a lanthanum-strontium-iron perovskite, a tin-lead perovskite, a formamidinium-cesium-lead(iodide-bromide) perovskite, some other perovskite, or some combination thereof. The photovoltaic material coating 902 may be applied to a finished foam product or a green carbon foam having sufficient electrical conductivity such as, for example, a finished foam product or a green carbon foam that includes a non-carbon-based material or an additive that induces or enhances electrical conductivity. In another further embodiment, the photovoltaic material coating 902 is applied to a finished foam product with increased electrical conductivity from graphitization.

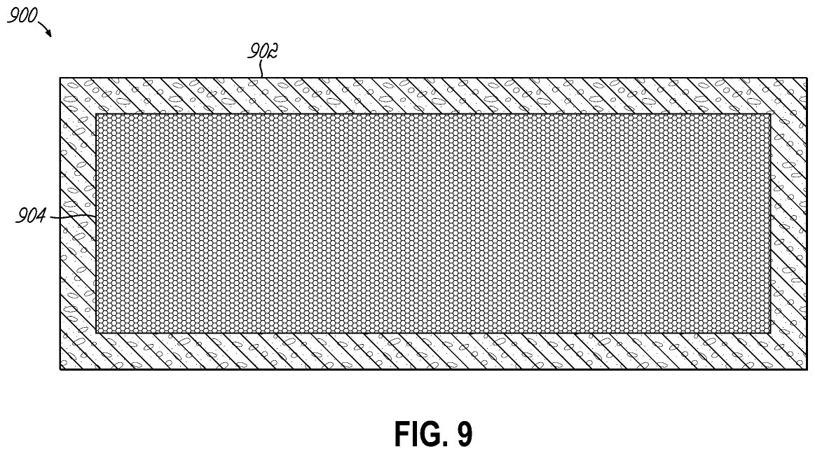

With respect to FIG. 9, the coal product 900 may include the coating layer 902 as described above and a carbon core 904. The carbon core 904 may include, for example, a finished carbon foam and/or a green carbon foam manufactured according to the system and method 100, 200, 400, 500 described above. In one such embodiment, the carbon core 904 includes a contiguous piece of green carbon foam. In further embodiment, the carbon core 904 consists entirely of a contiguous piece of green foam. In another such embodiment, the carbon core 904 includes a contiguous piece of vitrified carbon foam. In further embodiment, the carbon core 904 consists entirely of a contiguous piece of vitrified foam. In yet another such embodiment, the carbon core 904 includes a contiguous piece of calcinated foam. In further embodiment, the carbon core 904 consists entirely of a contiguous piece of calcinated carbon foam. In still another such embodiment, the carbon core 904 includes a contiguous piece of graphitized carbon foam. In further embodiment, the carbon core 904 consists entirely of a contiguous piece of graphitized carbon foam.

The carbon core 904 may include one or more layers of the green carbon foam and/or the finished carbon foam manufactured according to the system and method 100, 200, 400, 500 described above. In one embodiment, the carbon core 904 includes a plurality of layers. The carbon core 904 may include a plurality of layers with different properties. In one such further embodiment, the plurality of layers includes foams made according to different manufacturing conditions such as, for example, at least one green carbon foam layer and at least one vitrified carbon foam layer, at least one green carbon foam layer and at least one calcinated carbon foam layer, at least one green carbon layer and at least one graphitized carbon foam layer, at least one vitrified carbon foam layer and at least one calcinated carbon foam layer, at least one vitrified carbon foam layer and at least one graphitized carbon foam layer, or at least one calcinated carbon foam layer and at least one graphitized carbon foam layer. In another such embodiment, the plurality of layer may comprise layers having different properties stemming from other factors in the system and method 100, 200, 400, 500 such as, for example, different additives, different temperatures within the float bath 300, different durations within the float bath 300, using a plurality of float baths 300 in series configured to have different temperatures, different temperatures within the extruder 600, 700, 800, different durations within the extruder 600, 700, 800, different temperatures within different portions of the extruder 600, 700, 800, different temperatures within the optional kiln 140, different durations within the optional kiln 140, different coatings applied at the optional primer device 142, or some combination thereof.

Referring generally to embodiments where one or more temperature is selected based in part on the Gieseler properties of the carbon source material used, the carbon source material used may comprise a caking coal or mixture thereof. In one embodiment the carbon source material may comprise Itmann metallurgical coal. In a yet further embodiment, the Itman metallugical coal may be collected from seam Pocahontas #3. Upon information and belief, Itmann coal generally has Gieseler properties wherein the softening temperature is approximately 437° C., the maximum fluidity temperature is approximately 482° C., and wherein the solidification temperature is approximately 513° C. In another embodiment, the carbon source material used may comprise Pittsburgh No. 8 coal. Upon information and belief, Pittsburgh No. 8 coal has Gieseler properties wherein the softening temperature is approximately 380° C., the maximum fluidity temperature is approximately 431° C., and wherein the solidification temperature is approximately 471° C.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

What is claimed is:

1. A system configured to continuously produce a coal product, wherein the coal product is selected from the list consisting of a green carbon foam, a finished carbon foam, and a coal siding product, the system comprising:
a carbon source material tank;
an air heater;
a pulverizer, wherein the pulverizer is configured to receive a carbon source material from the carbon source material tank, wherein the pulverizer is configured to receive heated air from the air heater, and wherein the pulverizer is configured to produce a pulverized carbon source material; and
a green carbon foam processing device selected from the group consisting of a float bath and an extruder, wherein the green carbon foam processing device is configured to receive a material selected from the group consisting of the pulverized carbon source material and a carbon material sheet, wherein the green carbon foam processing device is configured to have a temperature greater than the softening temperature and less than the solidification temperature of the carbon source material, and wherein the green carbon foam processing device is configured to produce a green carbon foam.

2. The system of claim 1, wherein the carbon source material comprises a caking coal.

3. The system of claim 2, wherein the caking coal comprises a coal selected from the list consisting of Pittsburgh No. 8 coal, White Forest Coal, and Itmann coal.

4. The system of claim 1 further comprising a first mesh having a first mesh size, wherein the first mesh is configured to receive the pulverized carbon source material prior to the green carbon foam processing device, and wherein the green carbon foam device is configured to receive only the carbon source material having a size smaller than the openings of the first mesh.

5. The system of claim 4, wherein the first mesh size is selected from the list consisting of an 80M size, a 35M size, and a 14M size.

6. The system of claim 4, further comprising a second mesh having a second mesh size, wherein the second mesh size is larger than the first mesh size, wherein the second mesh is configured to receive the pulverized carbon source material from the first mesh prior to the green carbon processing device, and wherein the green carbon foam device is configured to receive only the carbon source material having a size larger than the openings of the second mesh.

7. The system of claim 6, wherein the second mesh size is selected from the list consisting of an 80M size and a 35M size.

8. The system of claim 1, further comprising:
a blender configured to receive the pulverized carbon source material prior to the green carbon foam processing device, wherein the blender is configured to mix together all received components; and
an additives tank configured to supply one or more additive to a device selected from the group consisting of the pulverizer and the blender.

9. The system of claim 8, wherein the one or more additive includes graphite, and wherein graphite is included in an amount greater than or equal to 0.01 wt. % and less than or equal to 10 wt. % by weight of the mixture.

10. The system of claim 8, wherein the one or more additive includes carbon fiber, and wherein carbon fiber is included in an amount greater than or equal to 0.01 wt. % and less than or equal to 10 wt. % by weight of the mixture.

11. The system of claim 8, wherein the one or more additive includes a binder selected from the list consisting of cellulose, methyl cellulose, and some combination thereof, wherein the binder is included in an amount less than or equal to 10 wt. % by weight of the mixture.

12. The system of claim 1 further comprising a kiln, wherein the kiln is configured to receive the green carbon foam from the green carbon foam processing device, and wherein the kiln is configured to produce a finished carbon foam.

13. The system of claim 12 further comprising a primer device, wherein the primer device configured to receive the finished carbon foam from the kiln, and wherein the primer device is configured to produce a coal siding product.

14. The system of claim 1 further comprising a primer device, wherein the primer device is configured to receive the green carbon foam from the green carbon foam processing device, and wherein the primer device is configured to produce a coal siding product.

15. The system of claim 1 further comprising a pulling device, wherein the pulling device is positioned downstream from the green carbon foam processing device and is configured to receive the green carbon foam only after the green carbon foam is cooled to solidify.

16. The system of claim 1, wherein the green carbon foam device is configured to have a maximum operating temperature and a minimum operating temperature when producing a green carbon foam, and
wherein the maximum temperature is defined relative to the solidification temperature of the carbon source material, wherein the maximum operating temperature is selected from a list consisting of at least 5° C. below the solidification temperature, at least 10° C. below the solidification temperature, at least 20° C. below the solidification temperature, and at least 30° C. below the solidification temperature; and
wherein the minimum temperature is defined relative to the softening temperature of the carbon source material, wherein the minimum temperature is selected from a list consisting of at least 5° C. above the softening temperature, at least 10° C. above the softening temperature, at least 20° C. above the softening temperature, and at least 30° C. above the softening temperature.

17. The system of claim 1, wherein the green carbon foam processing device is an extruder, and wherein the extruder comprises a two-stage auger, the two stage auger comprising:
a first portion configured to be heated to a first temperature, wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and
a second portion configured to be heated to a second temperature, wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

18. The system of claim 1, wherein the green carbon foam processing device comprises a first float bath that is configured to have a first temperature, and wherein the system further comprises a second float bath configured to receive the output from the first float bath, wherein the second float bath is configured to have a second temperature;
wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and
wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

19. A method for continuously producing a coal product, wherein the coal product is selected from the list consisting of a green carbon foam, a finished carbon foam, and a coal siding product, the method comprising:
drying a carbon source material;
pulverizing the carbon source material to produce a pulverized carbon source material;
processing the pulverized carbon source material to produce a green carbon foam, wherein said processing comprises using a green carbon foam processing device selected from the group consisting of a float bath and an extruder, wherein said processing comprises:
maintaining the pulverized carbon source material at a temperature greater than the softening temperature of the carbon source material; and
maintaining the pulverized carbon source material at a temperature less than the solidification temperature of the carbon source material.

20. The method of claim 19, wherein the carbon source material comprises a caking coal.

21. The method of claim 20, wherein the caking coal comprises a coal selected from the list consisting of Pittsburgh No. 8 coal, White Forest Coal, and Itmann coal.

22. The method of claim 19 further comprising a first mesh separation step using a first mesh, wherein the first mesh has a first mesh size, wherein the first mesh separation step occurs prior to processing the pulverized carbon source material to produce the green carbon foam, and wherein only the carbon source material having a size smaller than the openings of the first mesh is processed to produce the green carbon foam.

23. The method of claim 22, wherein the first mesh size is selected from the list consisting of an 80M size, a 35M size, and a 14M size.

24. The method of claim 22, further comprising a second mesh separation step using a second mesh, wherein the second mesh has a second mesh size that is larger than the first mesh size, wherein the second mesh separation step occurs after the first mesh separation step and before processing the pulverized carbon foam to produce a green carbon foam, and wherein only the carbon source material having a size larger than the openings of the second mesh is processed to form a green carbon foam.

25. The method of claim 24, wherein the second mesh size is selected from the list consisting of an 80M size and a 35M size.

26. The method of claim 19, further comprising:
prior to processing the pulverized carbon source material to produce the green carbon foam, adding one or more additive to one of the carbon source material and/or the pulverized carbon source material; and
prior to processing the pulverized carbon source material to produce the green carbon foam, mixing the pulverized carbon source material and the one or more additive together.

27. The method of claim 26, wherein the one or more additive includes graphite, and wherein graphite is included in an amount greater than or equal to 0.01 wt. % and less than or equal to 10 wt. % by weight of the mixture.

28. The method of claim 26, wherein the one or more additive includes carbon fiber, and wherein carbon fiber is included in an amount greater than or equal to 0.01 wt. % and less than or equal to 10 wt. % by weight of the mixture.

29. The method of claim 26, wherein the one or more additive includes a binder selected from the list consisting of cellulose, methyl cellulose, and some combination thereof, and wherein the binder is included in an amount less than or equal to 10 wt. % by weight of the mixture.

30. The method of claim 19 further comprising processing the green carbon foam to produce finished carbon foam, wherein processing the green carbon foam to produce a finished carbon foam comprises a heat-treatment process selected from the list consisting of vitrification, calcination, and graphitization.

31. The method of claim 30 further comprising applying a coating to the finished carbon foam to produce a coal siding product.

32. The method of claim 19 further comprising applying a coating to the green carbon foam to produce a coal siding product.

33. The method of claim 19 further comprising:
after producing the green carbon foam, allowing the green carbon foam to cool to solidify; and
after allowing the green carbon foam to cool to solidify, pulling the green carbon foam downstream from the green carbon foam processing device.

34. The method of claim 19, wherein maintaining the pulverized carbon source material at a temperature greater than the softening temperature of the carbon source material comprises maintaining a minimum temperature, wherein the minimum temperature is selected from a list consisting of at least 5° C. above the softening temperature, at least 10° C. above the softening temperature, at least 20° C. above the softening temperature, and at least 30° C. above the softening temperature; and
wherein maintaining the pulverized carbon source material at a temperature less than the solidification temperature of the carbon source material comprises maintaining a maximum temperature, wherein the maximum operating temperature is selected from a list consisting of at least 5° C. below the solidification temperature, at least 10° C. below the solidification temperature, at least 20° C. below the solidification temperature, and at least 30° C. below the solidification temperature.

35. The method of claim 19, wherein the green carbon foam processing device is an extruder having a two stage auger, the two stage auger comprising a first portion and a second portion, the method further comprising:
maintaining the first portion at a first temperature, wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and
maintaining the second portion at a second temperature, wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

36. The method of claim 19, wherein processing the pulverized carbon source material to produce a green carbon foam comprises using a first float bath and a second float bath, the method further comprising:
maintaining the first float bath at a first temperature, wherein the first temperature is defined relative to the maximum fluidity temperature of the carbon source material, wherein the first temperature is selected from the list consisting of ±5° C. relative to the maximum fluidity temperature, ±10° C. relative to the maximum fluidity temperature, ±20° C. relative to the maximum fluidity temperature, and ±30° C. relative to the maximum fluidity temperature; and
maintaining the second float bath at a second float bath temperature, wherein the second temperature is defined relative to the solidification temperature of the carbon source material; wherein the second temperature is selected from the list consisting of at least 5° C. below the solidification temperature, at least 10° C. below the solidification temperature, at least 20° C. below the solidification temperature, and at least 30° C. below the solidification temperature.

37. The method of claim 19, wherein processing the pulverized carbon source material to produce a green carbon foam comprises using a float bath, the method further comprising:
immediately prior to processing the pulverized carbon source material to produce a green carbon foam, processing the pulverized carbon source material to produce a carbon material sheet, wherein processing the pulverized carbon source material to produce a green carbon foam comprises processing the carbon material sheet to produce a green carbon foam.
